(19) United States
(12) Patent Application Publication
(10) Pub. No.: US 2002/0133606 A1
(43) Pub. Date: Sep. 19, 2002

(54) Filtering apparatus, filtering method and computer product

(75) Inventors: Masashi Mitomo, Kawasaki (JP); Satoru Torii, Kawasaki (JP); Seigo Kotani, Kawasaki (JP); Fumie Takizawa, Kawasaki (JP); Etsuo Ono, Kawasaki (JP); Osamu Koyano, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/087,807

(22) Filed: Mar. 5, 2002

Related U.S. Application Data
(63) Continuation-in-part of application No. 09/911,511, filed on Jul. 25, 2001.

(30) Foreign Application Priority Data
Mar. 13, 2001 (JP) 2001-071214
Dec. 20, 2001 (JP) 2001-388444

(51) Int. Cl. G06F 15/16

(52) U.S. Cl. 709/229

(57) ABSTRACT

A filtering apparatus includes an illegal request DB (database) which stores patterns of illegal accesses to a Web server, an estimation section which estimates the legality of an access request from a client device based on the illegal access patterns stored in the illegal request DB and on a predetermined estimation rule, and a determination section which determines whether the access request is to be transmitted to the Web server based on an estimation result of the estimation section and on a predetermined determination rule.

### FIELD OF THE INVENTION

The present invention relates to a filtering apparatus interposed between clients and a server which provides services according to access requests from the clients, and giving only a legal access request among the access requests to the server, a filtering method and a program which allows a computer to execute the filtering method.

### BACKGROUND OF THE INVENTION

In recent years, as network technology advances, the use of the WWW (World Wide Web) which is a distribution system on the Internet rapidly increases and the number of various types of HTTP servers which provide various services according to various requests from clients increases, accordingly. However, as the number of servers increases, the number of illegal accesses from clients to servers increases.

Specifically, illegal accesses described below increase. That is, intruders or attackers illegally use the servers of companies, organizations or individuals without rights to do so, obstruct the operations of the servers, or crack the server. The users of the servers conduct behaviors other than those permitted by the rights given to the users through the network on purpose. The need to ensure the reliability of each server by rejecting an illegal access to the server is, therefore, increasingly voiced.

Conventionally and normally, a firewall is established between the Internet and the LAN (Local Area Network) of each company so as to protect a server from an illegal access from each client.

This firewall is software which prevents external invasion into a computer or a network connected to the Internet. A computer that functions as the firewall (“firewall computer”), which is designed to permit only specific data and a specific protocol, is disposed between the company LAN and the Internet. By permitting data exchange between the LAN and the outside of the LAN only through the computer, external invasion is prevented.

In the firewalls, network-base and host-base illegal access detection methods are known. In the former method, i.e. the network-base illegal access detection method, raw packets flowing in the network are monitored and an illegal access is detected based on the monitoring of the raw packets. In the latter method, i.e. host-base illegal access detection method, a log history stored in a host is monitored and an illegal access is detected based on the monitoring of the log history.

The client that makes the illegal access (“transmitting end client”) is tracked based on the discovered illegal access and information such as the IP address of the client who conducts this illegal access (“transmitting end information”) is stored in the firewall computer. If a client tries to make an access and if transmitting end information corresponding to that client has been stored in the firewall computer, then the access request from that client is rejected considering that the access is an illegal access.

However, according to the conventional art explained above, the client who illegally accessed the server in the past is recognized as an illegal client and an access request from this illegal client is rejected as an illegal access. Although it is possible to protect the server from the illegal access after the client is recognized as an illegal client, it is disadvantageously impossible to protect the server from an illegal access from a client who is not recognized as an illegal client. In other words, the server cannot be protected from an initial illegal access before the recognition of an illegal client.

How to protect the server from an illegal access from a client who is not recognized as an illegal client is quite significant. Desirably, it is necessary to create a framework which predetermines whether a certain access request is a legal access request or an illegal access request without giving consideration to information on a transmitting end which transmits the access request.

### SUMMARY OF THE INVENTION

It is an object of this invention to provide a filtering apparatus which can protect a server from an illegal access from a client who is not recognized as an illegal client, a filtering method and a computer program which allows a computer to execute this filtering method.

In the filtering apparatus according to one aspect of this invention, an estimation section estimates the legality of each of access requests from client devices based on illegal access patterns and on a predetermined estimation rule while referring to an illegal request DB (database) which stores patterns of illegal accesses to a Web server. In addition, a determination section determines whether each of the access requests is to be transmitted to the Web server based on the estimation result of the estimation section and on a predetermined determination rule. It is, therefore, possible to determine whether the access request is an illegal access based on not transmitting end information on the access request but the concrete request content of the access request.

The filtering method according to another aspect of this invention comprises an estimation step of referring to an illegal pattern database which stores patterns of illegal accesses to the server, and estimating legality of each of the access requests based on the illegal access patterns stored in the illegal pattern database and on a predetermined estimation rule; and a determination step of determining whether each of the access requests is to be transmitted to the server based on an estimation result in the estimation step and on a predetermined determination rule.

The computer program according to still another aspect of this invention allows a computer to execute the method of the above-mentioned invention.

Other objects and features of this invention will become apparent from the following description with reference to the accompanying drawings.

### BRIEF DESCRIPTION OF THE DRAWINGS

FIG. 1 is a block diagram which shows the configuration of a server-client system in a first embodiment according to this invention,

FIG. 2 shows an example of the structure of information stored in an illegal request DB,

FIG. 3 is a flow chart which explains filtering processing procedures in the first embodiment,

FIG. 4 is a flow chart which explains filtering processing procedures in a second embodiment according to this invention,

FIG. 5 is a block diagram which shows the configuration of a server-client system in a third embodiment according to this invention,

FIG. 6 is a flow chart which explains filtering processing procedures in the third embodiment,

FIG. 7 is a block diagram which shows the configuration of a server-client system in a fourth embodiment according to this invention,

FIG. 8 is a flow chart which explains filtering processing procedures in the fourth embodiment,

FIG. 9 is a block diagram which shows the configuration of a server-client system in the modification of the fourth embodiment,

FIG. 10 is a block diagram which shows the configuration of a server-client system in a fifth embodiment according to this invention,

FIG. 11 is a block diagram which shows the configuration of a server-client system in a sixth embodiment according to this invention,

FIG. 12 is a flow chart which explains filtering processing procedures in the sixth embodiment,

FIG. 13 is a block diagram which shows the configuration of a server-client system in a seventh embodiment according to this invention,

FIG. 14 is a block diagram which shows the configuration of a server-client system in an eighth embodiment according to this invention,

FIG. 15 is a flow chart which explains filtering processing procedures in the eighth embodiment,

FIG. 16 is a block diagram which shows the configuration of a server-client system in a ninth embodiment according to this invention,

FIG. 17 is a flow chart which explains filtering processing procedures in the ninth embodiment,

FIG. 18 is a block diagram which shows the configuration of a server-client system in a tenth embodiment according to this invention, and

FIG. 19 is a flow chart which explains filtering processing procedures in the tenth embodiment.

### DETAILED DESCRIPTION

Embodiments of the filtering apparatus, the filtering method and the program which allows a computer to execute the filtering method, will be explained hereinafter in detail with reference to the accompanying drawings. In the first to third embodiments, a case in which a filtering technique according to this invention is applied to a server device which provides a service according to an HTTP (HyperText Transfer Protocol) request from a client device will be explained.

In a first embodiment, an instance in which it is determined whether an HTTP request from a client device is an illegal access according to whether the HTTP request coincides with an illegal request pattern, will be explained.

(1) Overall System Configuration

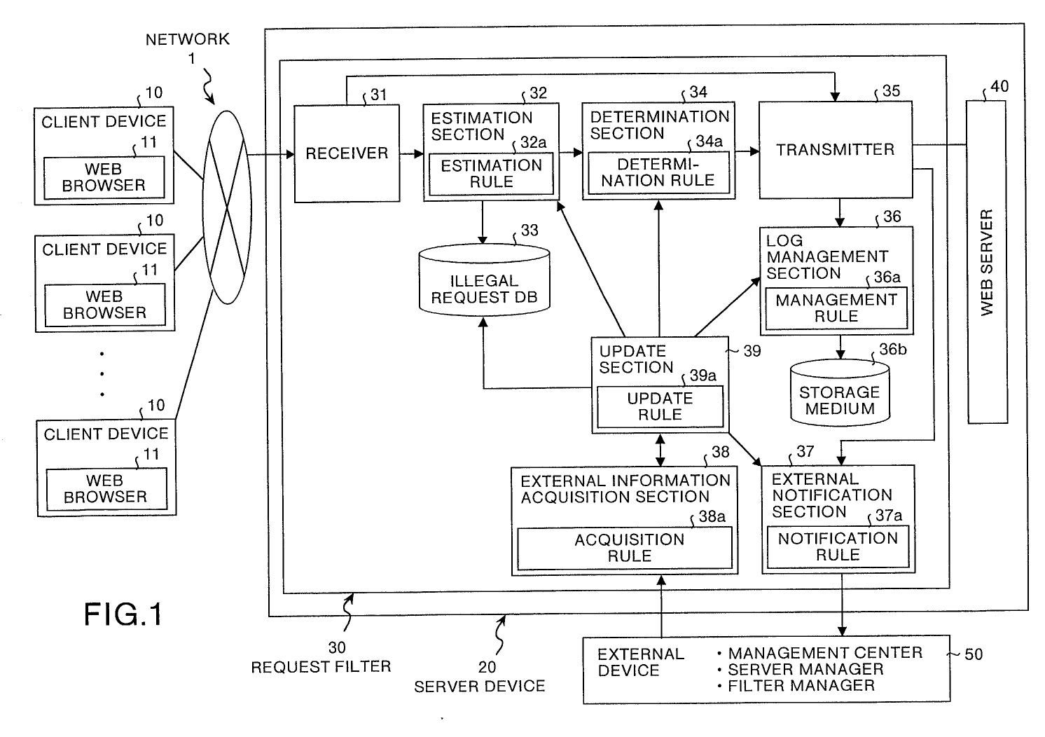

The configuration of a server-client system in the first embodiment will be first explained. FIG. 1 is a block diagram which shows the configuration of the server-client system in the first embodiment. As shown in FIG. 1, the server-client system in the first embodiment is constituted so that a plurality of client devices 10 each having a Web browser 11 and a server device 20 having a request filter 30, which serves as a filtering apparatus, and a Web server 40 are connected to communicate with each other via a network 1 such as the Internet.

Schematically, in this server-client system, the client devices 10 issue processing requests of various types such as HTTP requests to the server device 20 using the respective Web browsers 11. The Web server 40 of the server device 20 provides a service according to the HTTP request from each client device 10, to the client device 10. The request filter 30 of the server device 20, which is interposed between the client devices 10 and the Web server 40, transmits only a legal request among the HTTP requests from the respective client devices 10 to the Web server 40.

On the server-client system according to the first embodiment, a filtering processing is conducted by the request filter 30 of the server device 20. Specifically, the estimation section 32 of the request filter 30 makes an estimate that an HTTP request from a certain client device 10 is an illegal access if the HTTP request corresponds to any one of illegal access patterns stored in an illegal request DB 33. The determination section 34 of the request filter 30 determines that the HTTP request estimated as an illegal access by the estimation section 32 is not transmitted to the Web server 40. As a result, the request filter 30 can transmit only the legal HTTP request to the Web server 40 without considering information on a transmitting end which transmits the HTTP request.

(2) Configuration of Client Device

The configuration of each client device 10 shown in FIG. 1 will next be explained. As shown in this figure, each client device 10 has a Web browser 11. The client device 10 basically issues a processing request, such as an HTTP request, to the server device 20, interprets Web data provided by the Web server 40 of the server device 20 and conducts display control (browsing) which displays the interpreted data on an-output section such as a monitor.

Each client device 10 also functions as a device which can illegally access the server device 20 by a vicious usage. That is, if a vicious user such as an intruder or an attacker uses the client device 10, the client server 10 can illegally access the server device 20 including viewing a file such as a password file on the Web server 40 which remote users should not view, requesting a file which does not exist on the Web server 40 to thereby stop the function of the Web server 40, issuing a request including a command character string to thereby execute an arbitrary system command on the Web server 40. It is the request filter 30 that protects the Web server 40 from such an illegal access from the client device 10.

Each client device 10 can be realized by, for example, a personal computer, a workstation, a home game machine, an Internet TV, a PDA (Personal Digital Assistant) or a mobile communication terminal such as a cellular phone or a PHS (Personal Handy Phone System). In addition, each client device 10 is connected to a communication device such as a modem, a TA or a router through a telephone line, or connected to a network 1 through a dedicated line. The client device 10 can, therefore, access the server device 20 in accordance with a predetermined communication protocol (e.g., the TCP/IP Internet protocol).

(3) Configuration of Web Server in Server Device

The configuration of the Web server 40 provided in the server device 20 shown in FIG. 1 will next be explained. As shown in this figure, the Web server 40 of the server device 20 receives an HTTP request from each client device 10 through the request filter 30 and provides a service, such as the transmission of various items of information described in a markup language such as the HTML (HyperText Markup Language) in accordance with this HTTP request, to the client device 10.

In terms of a functional concept, the Web server 40 performs the same operations as those of an ordinary Web server. However, this Web server 40 differs from the ordinary Web server and does not monitor the TCP (Transmission Control Protocol) port with port number 80 allocated to the HTTP request in the server device 20.

That is, the Web server 40 does not directly receive the HTTP request from the client device 10. Instead, the request filter 30 receives the HTTP request, holds inter-process communication and transmits only a legal HTTP request to the Web server 40.

(4) Configuration of Request Filter in Server Device

The configuration of the request filter 30 provided in the server device 20 shown in FIG. 1 will be explained. As shown in this figure, the request filter 30 includes the receiver 31, estimation section 32, illegal request DB 33, determination section 34, transmitter 35, log management section 36, external notification section 37, external information acquisition section 38 and the update section 39.

Among these constituent sections of the request filter 30, the receiver 31 is a processing section which monitors the TCP port with port number 80 in the server device 20 and receives an HTTP request from the client device 10 before the Web server 40 receives. The HTTP request which the receiver 31 receives from the client device 10 is output to the estimation section 32 and the transmitter 35.

The estimation section 32 is a processing section which estimates the legality of the HTTP request based on illegal access patterns stored in the illegal access DB 33 and on a predetermined estimation rule 32a, and which outputs the estimation result to the determination section 34.

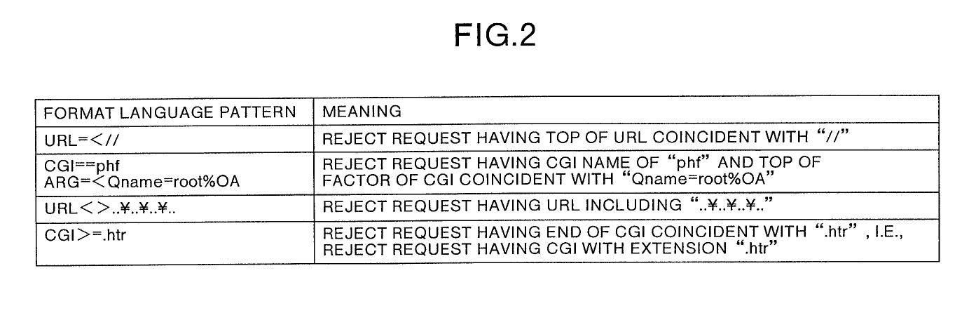

The illegal request DB 33 referred to by the estimation section 32 when the estimation section 32 makes an estimate will be explained. FIG. 2 is a block diagram which shows an example of the structure of information stored in the illegal request DB 33. As shown in this figure, the illegal request DB 33 is a database which stores illegal access patterns with respect to the server. The illegal request DB 33 stores a plurality of patterns on which illegal accesses collected in the network world are described in formal languages, respectively.

The pattern “URL=<//” shown in FIG. 2, for example, means an illegal request having “//” on the top of the URL (Uniform Resource Locator) thereof. The pattern “CGI=phf, ARG=<Qname=root %OA” means an illegal request having a CGI (Common Gateway Interface) name of “phf” and having “Qname=root %OA” on the top of a certain factor thereof. The pattern “URL<>. . ¥ . . ¥ . . ¥ . .” means an illegal request including “. . ¥. ¥. ¥ . . ” in the URL thereof. The pattern “CGI>=.htr” means an illegal request having “.htr” at the end of a CGI name.

Although not shown in FIG. 2, the illegal request DB 33 also stores a plurality of illegal command character strings each of which executes an arbitrary system command on the Web server 40. By storing the patterns of these command character strings in the illegal request DB 33, it is possible to protect the Web server 40 not only from an illegal access using a known attacking method but also an illegal access using an unknown attacking method.

By referring to the illegal request DB 33, the estimation section 32 estimates the legality of the HTTP request based on a predetermined estimation rule 32a. Specifically, if the HTTP request corresponds to any one of the illegal access patterns stored in the illegal request DB 33, the estimation section 32 estimates that the HTTP request is an illegal access. If the HTTP request does not correspond to any illegal access patterns stored in the illegal request DB 33, the estimation section 32 estimates that the HTTP request is a legal access.

Referring back to FIG. 1, the determination section 34 is a processing section which determines whether to transmit the HTTP request to the Web server 40 or not based on an estimation result received from the estimation section 32 and on a predetermined determination rule 34a, and which outputs this determination result to the transmitter 35. Specifically, if receiving the estimation result to the effect that the HTTP request is an illegal access, from the estimation section 32, the determination section 34 determines that the HTTP request is not transmitted to the Web server 40 (reject determination). If receiving the estimation result to the effect that the HTTP request is a legal access from the estimation section 32, the determination section 34 determines that the HTTP request is transmitted to the Web server 40 (approval determination).

The transmitter 35 is a processing section which controls the transmission of the HTTP request received from the receiver 31 based on the determination result received from the determination section 34. Specifically, if receiving the approval determination from the determination section 34, the transmitter 35 transmits the HTTP request to the Web server 40 over the inter-process communication. If receiving the reject determination from the determination section 34, the transmitter 35 rejects the transmission of the HTTP request to the Web server 40 and abandons this illegal request.

The log management section 36 is a processing section which stores and manages information on the illegal request, which is determined not to be transmitted to the Web server 40 by the determination section 34, in a storage medium 36b based on a predetermined management rule 36a. Specifically, the log management section 36 selectively edits information on the illegal request such as the content of the illegal request, transmitting end information (IP address and host name), transmission time, the basis of the estimation result of the estimation section 32 and the basis of the determination result of the determination section 34 based on the management rule 36a, and selectively stores the selectively edited information in the storage medium 36b in accordance with the cracking level of the illegal request. For example, the log management section 36 stores only illegal requests having high cracking levels.

The information stored in the storage medium 36b can be output to the outside of the server device 20 by taking out the storage medium 36b, through the communication line or the like. In addition, if analyzing the information stored in the storage medium 36b to thereby analyze an illegal access trend, it is possible to take measures to further maintain the Web server 40.

The external notification section 37 is a processing section which notifies an external device 50 of information on the illegal request which is determined not to be transmitted to the Web server 40 by the determination section 34, based on a predetermined notification rule 37a. Specifically, the external notification section 37 selectively edits information on the illegal request including the content of the illegal request, transmitting end information (IP address and host name), transmission time, the basis of the estimation result of the estimation section 32, the basis of the determination result of the determination section 34 and the like, based on the notifying rule 37a, and selectively notifies the external device 50 of the selectively edited information according to the cracking level of the illegal request as in the instance of the processing of the log management section 36.

The external device 50 which receives the notification from the external notification section 37, is a communication device which is operated by the operator of the Web server 40, the manager of the request filter 30, the manager of the overall server device 20, the manager of a public institution (management center) which monitors the overall network or the like (which will be generally referred to as “manager” hereinafter). The external notification section 37 promptly, real-time notifies the manager of, for example, the illegal request having a high cracking level and batch-notifies the manager of, for example, the illegal requests having low cracking levels in anon real-time manner. In this way, the external notification section 37 can promptly urge the manager who receives such a notification to take measure for the maintenance of the Web server 40.

The external information acquisition section 38 is a processing section which actively or passively acquires information used in the update processing of the update section 39 from the external device 50, the outside of the request filter 30 of the Web server 40 or the like. For example, the external information acquisition section 38 acquires a new illegal request pattern which the manager inputs through the external device 50, change instruction information on the estimation rule 32a which the manager inputs through the external device 50 and the like. In addition, the external information acquisition section 38 acquires information on the damage status of the Web server 40 which is damaged by the illegal request, and the content of the illegal access from the Web server 40. The predetermined rule 38a is a rule which specifies the acquisition of only information from the manager having an authenticated right.

The update section 39 is a processing section which updates information stored in the illegal request DB 33, the estimation rule 32a, the update rule 34a, the management rule 36a, the notification rule 37a, the acquisition rule 38a, or a predetermined update rule 39a based on the predetermined update rule 39a. If receiving a new illegal request pattern from the external information acquisition section 38, for example, the update section 39 stores this illegal request pattern in the illegal request DB 33. If receiving change instruction information on the estimation rule 32a, the update section 39 changes the estimation rule 32a in accordance with this change instruction information. By allowing the update section 39 to perform these update processings, it is possible to readily deal with always developing illegal accesses.

(5) Filtering Processing

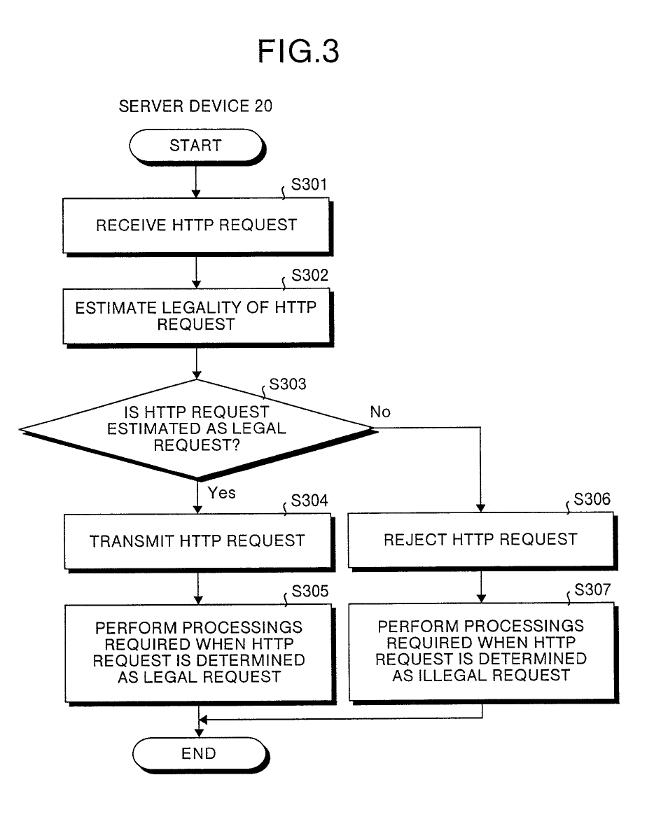

Filtering processing procedures in the first embodiment will be explained. FIG. 3 is a flow chart which explains the filtering processing procedures in the first embodiment. As shown in this figure, the receiver 31 of the request filter 30 in the server device 20 receives an HTTP request from each client device 10 before the Web server 40 receives (step S301).

The estimation section 32 of the request filter 30 estimates the legality of the HTTP request based on the illegal access patterns stored in the illegal request DB 33 and on the predetermined estimation rule 32a (step S302). Specifically, if the HTTP request corresponds to any one of the illegal access patterns, the estimation section 32 estimates that the HTTP request is an illegal request. If the HTTP request does not correspond to any illegal access patterns, the estimation section 32 estimates that the HTTP request is a legal request.

The determination section 34 of the request filter 30 then determines whether the HTTP request is to be transmitted to the Web server 40 based on the estimation result received from the estimation section 32 and on the predetermined determination rule 34a (step S303). Specifically, the determination section 34 determines whether the estimation section 32 has estimated the HTTP request as a legal request.

If it is determined by the determination section 34 that the HTTP request is estimated as a legal request (“Yes” at step S303), the transmitter 35 of the request filter 30 transmits the HTTP request to the Web server 40 over the inter-process communication (step S304). The Web server 40 performs a processing which is performed when the legality of the request is determined, such as the transmission of information according to the HTTP request to the client device 10 (step S305).

Conversely, if it is determined by the determination section 34 that the HTTP request is estimated as an illegal request (“No” at step S303), the transmitter 35 of the request filter 30 rejects the transmission of the HTTP request to the Web server 40 (step S306). The respective sections of the request filter 30 perform processings required when the HTTP request is determined as an illegal request, such as abandonment of the illegal request, storage of information on the illegal request in the storage medium 36b, notification of the information on the illegal request to the external device 50 and the like, respectively (step S307).

As explained above, according to the first embodiment, it is possible to promptly, surely determine whether a certain access is an illegal access not by information on the transmitting end which transmits the access request but by whether the concrete content of the access request coincides with one of the illegal request patterns. It is, therefore, possible to promptly, surely protect the Web server 40 from the illegal access from the client device 10 which is not recognized as an illegal client.

A second embodiment of this invention will be explained below. The first embodiment has been explained with respect to the instance of determining whether the HTTP request from each client device 10 is an illegal access depending on whether the HTTP request coincides with one of the illegal request patterns. However, the present invention is not limited to the first embodiment. This invention is also applicable to an instance of determining whether an HTTP request is an illegal access in accordance with a degree to which the HTTP request corresponds to one of the illegal access patterns.

In the second embodiment, therefore, an instance of determining whether an HTTP request is an illegal access in accordance with a degree to which the HTTP access corresponds to one of the illegal access patterns, will be explained. Since the system configuration of a server-client system in the second embodiment is the same as that shown in FIG. 1, the configuration of the system will not be explained herein.

The estimation section 32 and the determination section 34 which are the characteristic parts of the second embodiment will first be explained. The estimation section 32 in the second embodiment calculates a predetermined estimation value in accordance with a degree to which an HTTP request from each client device 10 corresponds to one of the illegal access patterns stored in the illegal request DB 33, and outputs the estimation value to the determination section 34.

Specifically, by calculating the number of patterns coincident with the illegal access patterns, allocating a danger index to each pattern and calculating the danger index of the pattern coincident with one of the respective patterns or the like, the estimation section 32 calculates the estimation value which is referred to as DI (Danger Index) which indicates the danger degree of an HTTP request. The estimation value DI takes an integral value in a range of, for example, 1 to 100 and becomes higher as the HTTP request has a higher danger index.

The determination section 34 in the second embodiment compares the estimation value DI calculated by the estimation section 32 with a predetermined threshold value, determines whether the HTTP request is to be transmitted to the Web server 40 and outputs this determination result to the transmitter 35.

Specifically, if the predetermined threshold value is assumed as 50 and the determination section 34 receives an estimation value DI of not lower than 50 from the estimation section 32, then the determination section 34 determines that the HTTP request is not to be transmitted to the Web server 40 (reject determination). If receiving an estimation value DI of lower than 50 from the estimation section 32, the determination section 34 determines that the HTTP request is to be transmitted to the Web server 40 (approval determination).

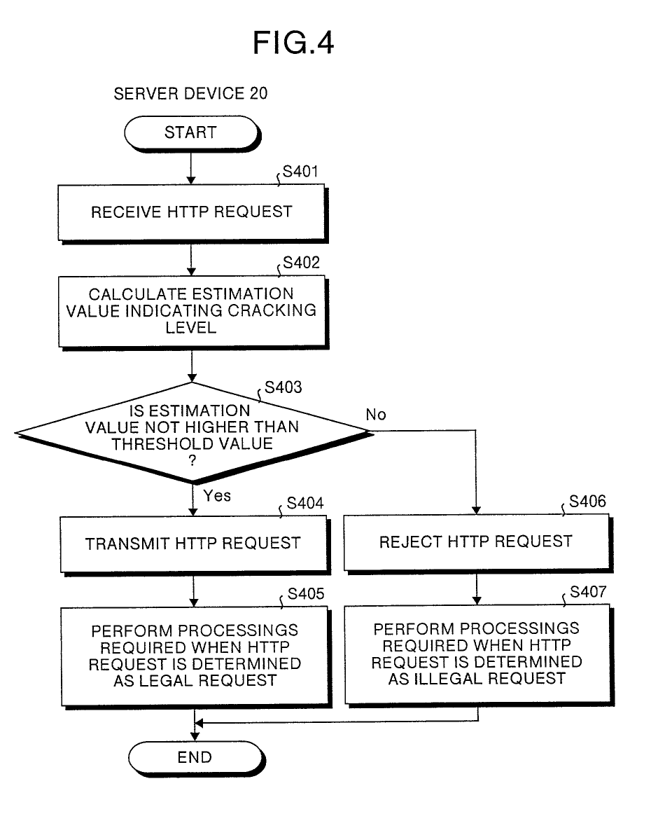

Filtering processing procedures in the second embodiment will next be explained. FIG. 4 is a flow chart which explains the filtering processing procedures in the second embodiment. As shown in this figure, the receiver 31 of the request filter 30 in the server device 20 receives an HTTP request from each client device 10 before the Web server 40 receives (step S401).

The estimation section 32 of the request filter 30 calculates an estimation value DI according to a degree to which the HTTP request corresponds to one of the illegal access patterns stored in the illegal request DB 33 (step S402). The determination section 34 of the request filter 30 compares the estimation value DI calculated by the estimation section 32 with the predetermined threshold value, and determines whether the HTTP request is to be transmitted to the Web server 40 (step S403). Specifically, the determination section 34 determines whether the estimation value DI is not lower than the predetermined threshold value.

If it is determined by the determination section 34 that the estimation value DI is lower than the predetermined threshold value (“Yes” at step S403), the transmitter 35 of the request filter 30 transmits the HTTP request to the Web server 40 over the inter-process communication (step S404). The Web server 40 performs a processing required when the HTTP request is determined as a legal request, such as the transmission of information according to the HTTP request to the client device 10 (step S405).

Conversely, if it is determined by the determination section 34 that the estimation value DI is not lower than the predetermined threshold value (“No” at step S403), the transmitter 35 of the request filter 30 rejects the transmission of the HTTP request to the Web server 40 (step S406). The respective sections of the request filter 30 perform processings required when the HTTP request is determined as an illegal request, including the abandonment of the illegal request, the storage of information on the illegal request in the storage medium 36b, the notification of the information on the illegal request to the external device 50 and the like, respectively (step S407).

As explained so far, according to the second embodiment, it is possible to determine whether the HTTP request is an illegal access while allowing a certain degree of a margin by comparing the estimation value with the threshold value. It is, therefore, possible to protect the Web server 40 from the illegal access from the client device 10 which is not recognized as an illegal client while allowing a certain degree of a margin.

A third embodiment of this invention will be explained below. The first and second embodiments have been explained with respect to the instance of making an estimate based on the illegal access patterns for the all HTTP requests from the client devices. However, this invention is not limited to this instance but is applicable to an instance of making an estimate for a part of the HTTP requests.

In the third embodiment, an instance of performing a filtering processing which consists of two hierarchies and making an estimate based on the illegal access patterns only for a part of HTTP requests will be explained.

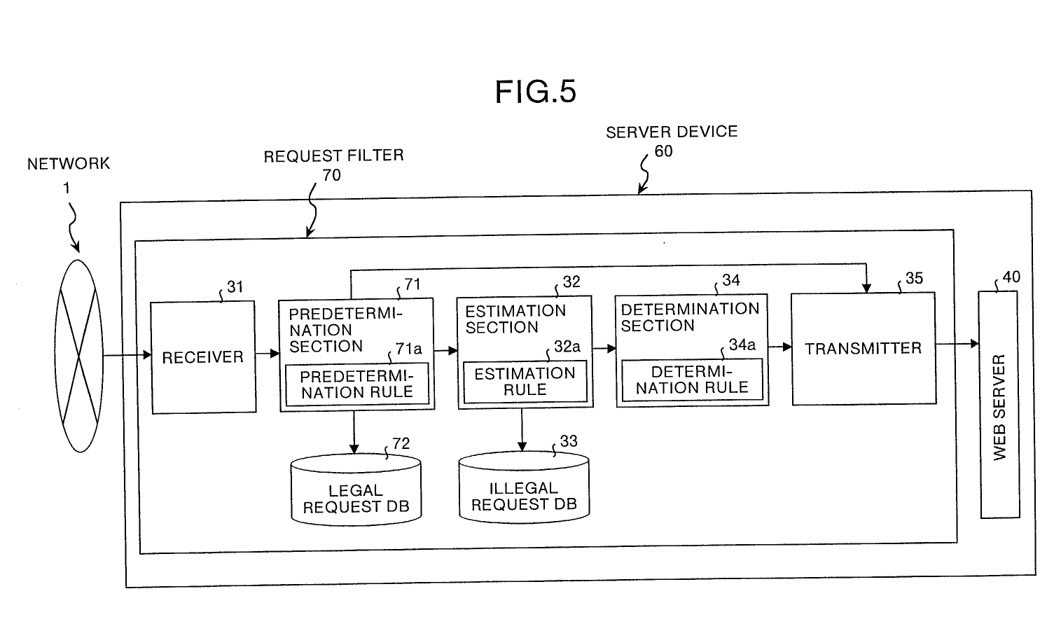

FIG. 5 is a block diagram which shows the configuration of a server-client system in the third embodiment according to this invention. In this figure, sections having the same functions as those shown in FIG. 1 are denoted by the same reference symbols and will not be explained in detail herein. A predetermination section 71 and a legal request DB 72 which are the characteristic parts of the third embodiment will be explained.

The predetermination section 71 of a request filter 70 in a server device 60 is a processing section which determines, prior to the estimate of legality by the estimation section 32, whether it is possible to dispense with the estimate of HTTP requests based on legal access patterns stored in the legal request DB 72 and on a predetermined predetermination rule 71a.

The legal request DB 72 referred to by the predetermination section 71 when this section 71 determines legality will be explained. This legal request DB 72 is a database which stores the patterns of legal accesses to the Web server 40. Specifically, the legal request DB 72 stores the paths of files which can be viewed by remote users among those existing on the Web server 40.

The files which can be viewed by the remote users are files except the flies such as a password file which the remote user should not view. They involve, for example, files which are hardly illegally accessed such as image files which are quite frequently requested by HTTP requests to the Web server 40.

By referring to such a legal request DB 72, the predetermination section 71 determines whether the estimate of an HTTP request can be dispensed with, based on the predetermined predetermination rule 71a. Specifically, if the HTTP request corresponds to any one of the legal access patterns stored in the legal request DB 72, the predetermination section 71 determines that the estimate of the HTTP request can be dispensed with. If the HTTP request does not correspond to any legal access patterns stored in the legal request DB 72, the predetermination section 71 determines that the estimate of the HTTP request cannot be dispensed with.

The predetermination section 71 outputs only the HTTP request the estimate of which is determined not to be dispensed with, to the estimation section 32. The predetermination section 71 transmits the HTTP request the estimate of which is determined to be dispensed with, to the Web server 40 via the transmitter 35 without the processings of the estimation section 32 and the determination section 34.

The legal access patterns stored in the legal request DB 72 are updated by the update section 39 whenever a new image file is added to the Web server 40 or the like.

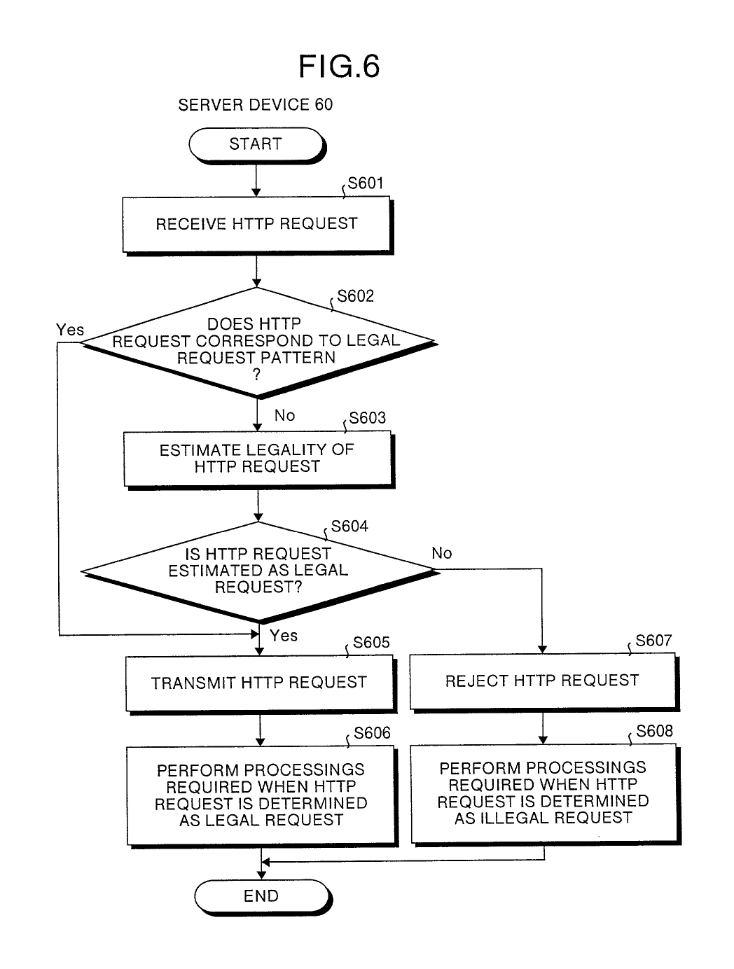

Filtering processing procedures in the third embodiment will be explained. FIG. 6 is a flow chart which explains the filtering processing procedures in the third embodiment. As shown in this figure, the receiver 31 of the request filter 70 in the server device 60 receives an HTTP request from each client device 10 before the Web server 40 receives (step S601).

The predetermination section 71 of the request filter 70 determines whether it is possible to dispense with the estimate of the HTTP request based on the legal access patterns stored in the legal request DB 72 and on the predetermined predetermination rule 71a (step S602). Specifically, the predetermination section 71 determines to which pattern among the legal access patterns stored in the legal request DB 72, the HTTP request corresponds.

If it is determined by the predetermination section 71 that the HTTP request corresponds to any one of the legal request patterns (“Yes” at step S602), the legality of this HTTP request is not estimated. The transmitter 35 of the request filter 70 transmits the HTTP request to the Web server 40 over inter-process communication (step S605). The Web server 40 performs processings required when the legality of an HTTP request is determined, including the transmission of information according to the HTTP request to the client device 10 and the like (step 606).

Conversely, if it is determined by the predetermination section 71 that the HTTP request does not correspond to any legal request patterns (“No” at step S602), the predetermination section 71 transmits this HTTP request to the estimation section 32 and the estimation section 32 performs the same filtering processing as that in the first or second embodiment (steps S603 to 608).

That is, the estimation section 32 of the request filter 70 estimates the legality of the HTTP request (step S603). The determination section 34 determines whether the HTTP request is to be transmitted to the Web server 40 (step S604).

If it is determined by the determination section 34 that the HTTP request is a legal request (“Yes” at step S604), the transmitter 35 of the request filter 70 transmits the HTTP request to the Web server 40 over the inter-process communication (step S605). The Web server 40 performs processings required when the legality of an HTTP request is determined, including the transmission of information according to the HTTP request to the client device 10 and the like (step S606).

Conversely, if it is determined by the determination section 34 that the HTTP request is an illegal request (“No” at step S604), the transmitter 35 of the request filter 70 rejects the transmission of the HTTP request to the Web server 40 (step S607). The respective sections of the request filter 70 perform processings required when an HTTP request is determined to be an illegal request, including the abandonment of the illegal request, the storage of information on the illegal request in the storage medium 36b, the notification of the information on the illegal request to the external device 50 and the like (step S608) As explained above, according to the third embodiment, the processings of the estimation section 32 and the determination section 34 for the HTTP request which is frequently requested but is low in cracking level such as the HTTP request which requests an image file can be dispensed with to thereby perform prompt processings. In addition, the estimation section 32 and the determination section 34 perform processings for the requests which is high in cracking level such as the HTTP request which requests a password file or a file which does not exist on the Web server 40 to make it possible to effectively protect the attack.

In the first to third embodiments, the instance of filtering the HTTP requests from the client devices 10 has been explained. The present invention is not limited to this instance. This invention is also applicable to an instance of filtering all the information input into the Web server 40 from the client devices 10 such as an FTP (File Transfer Protocol), a telnet and a console.

Further, in the first to third embodiments, the instance of providing the request filters 30 and 70 each of which serves as a filtering apparatus in the server devices 20 and 60 has been explained. This invention is not limited to this instance. For example, this invention is also applicable to all types of system configurations in which the request filter is interposed between the client devices and the Web server such as a configuration in which a request filter is provided on each client device side or in which a plurality of Web servers are protected by one request filter.

The filtering method which has been explained in the first to third embodiments can be realized by allowing a computer, such as a personal computer or a workstation, to execute a program prepared in advance. This program can be distributed through the network such as the Internet. Alternatively, the program can be executed by being recorded by a computer readable recording medium such as a hard disk, a flexible disk (FD), a CD-ROM, an MO or a DVD, and read by a computer from the recording medium.

A fourth embodiment of this invention will be explained below. In the first to third embodiments, the instance of referring to the illegal request DB 33 which stores the patterns of illegal accesses to the server and thereby abandoning the access request which can be recognized as an illegal access from the request content of the access request has been explained. However, this invention is not limited to this instance. This invention is also applicable to an instance of abandonment of an access request which is considered to be an illegal access based on the statistic of access requests to the server.

That is, as illegal accesses to the server, beside access requests considered to be illegal from the contents of the access request, there are access requests considered to be legal from the contents of access requests but considered to be illegal from the statistic of the access requests to the server. They are exemplified by access requests from the specific client device 10 or access requests consisting of the specific request content which the Web server receive in a centralized manner. Even if they are considered to be legal access from the individual contents, they should be considered to be intended at server down from the statistic of access requests.

The fourth embodiment is therefore configured to perform a filtering processing which estimates the legality of an access request by referring to not only the illegal request database but also a database that stores information on access requests considered to be illegal accesses from the statistic of access requests to the server, and which abandons an access request considered to be an illegal access based on the statistic of access requests to the server. The configuration of a server device in a server-client system in the fourth embodiment and filtering processing procedures in the fourth embodiment will be explained.

(1) Configuration of Server Device

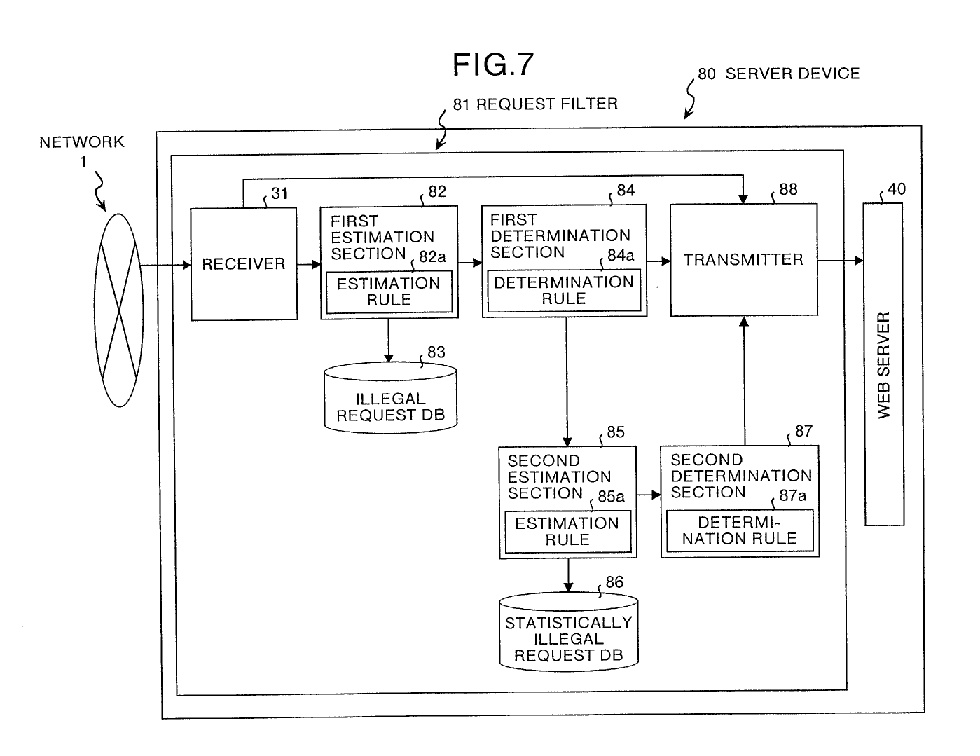

The configuration of the server device in the fourth embodiment will be explained. FIG. 7 is a block diagram which shows the configuration of the server-client system in the fourth embodiment. As shown in this figure, the server device 80 in the fourth embodiment includes the Web server 40 and request filter 81. The request filter 81 includes the receiver 31, first estimation section 82, illegal request DB 83, first determination section 84, second estimation section 85, a statistically illegal request DB 86, second determination section 87 and the transmitter 88.

Among these sections, the web server 40 and the receiver 31 have the same functions as those denoted by the same reference symbols shown in FIG. 1, respectively. In addition, the first estimation section 82, illegal request DB 83 and the first determination section 84 have the same functions as the estimation section 32, illegal request DB 33 and the determination section 34 shown in FIG. 1, respectively. Further, the first estimation section 82, illegal request DB 83 and the first determination section 84 execute the same processing as the filtering processing shown in the first or second embodiment, i.e., a filtering processing (pattern-based filtering processing) which abandons an HTTP request which is considered to be an illegal request from the request content thereof.

That is, the illegal request DB 83 is a database which stores the patterns of illegal accesses to the server. In addition, the first estimation section 82 estimates the legality of an HTTP request based on the illegal access patterns stored in the illegal request DB 83 and on a predetermined estimation rule 82a and outputs the estimation result (the estimation result or estimation value DI to the effect that the HTTP request is a legal request or an illegal request) to the first determination section 84.

The first determination section 84 determines whether the HTTP request is to be transmitted to the Web server 40 (i.e., whether the HTTP request is estimated as a legal request or whether the estimation value DI of the HTTP request is not higher than a predetermined threshold value) based on the estimation result received from the first estimation section 82 and on a predetermined determination rule 84a. The first determination section 84 then outputs this determination result to the transmitter 88 or outputs the HTTP request to the second estimation section 85.

As a result, the HTTP request considered to be an illegal request from the request content thereof, i.e., the HTTP request estimated as an illegal request or the HTTP request having the estimation value DI which is higher than the predetermined threshold value, is determined not to be transmitted to the Web server 40 and a reject determination is output to the transmitter 88.

On the other hand, the HTTP request not considered to be an illegal request from the request content thereof, i.e., the HTTP request estimated as a legal request or the HTTP request having the estimation value DI not higher than the predetermined threshold, is output to the second estimation section 85 so as to be subjected to the filtering processing (statistic-based filtering processing) which abandons the HTTP request considered to be an illegal request from the statistic of the HTTP requests to the Web server 40.

The second estimation section 85 is a processing section which estimates the legality of the HTTP request based on statistic information stored in the statistically illegal request DB 86 and on a predetermined estimation rule 85a, and which outputs the estimation result to the second determination section 87.

The statistically illegal request DB 86 is a database which stores information on access requests which are considered to be illegal accesses from the statistic of the access requests to the server. Specifically, the statistically illegal request DB 86 stores transmitting end information (IP address) on the client device 10 which issues requests exceeding a predetermined number within a preset time among the client devices 10 that transmit HTTP requests to the Web server 40, and also stores request contents of HTTP requests which are transmitted to the Web server 40 and the number of which exceeds a predetermined number within a preset time.

The statistically illegal request DB 86 stores these transmitting end information and request contents for the following reason. If the Web server 40 receives the HTTP requests from the specific client device 10 or the HTTP requests of the specific request content within a short time in a centralized manner, the requests can be considered to be illegal requests intended at server down.

The second estimation section 85 refers to the statistically illegal requests DB 86 which stores such information and thereby estimates the legality of the HTTP request based on a predetermined estimation rule 85a. Specifically, if the transmitting end information on the HTTP request corresponds to any one of the transmitting end information stored in the statistically illegal request DB 86 or the request content thereof corresponds to any one of the request contents stored in the statistically illegal request DB 86, then the second estimation section 85 estimates that the HTTP request is an illegal request.

On the other hand, if the transmitting end information on the HTTP request does not correspond to any transmitting end information stored in the statistically illegal request DB 86 and the request content thereof does not correspond to any request contents stored in the statistically illegal request DB 86, then the second estimation section 85 estimates that the HTTP request is a legal request.

The second determination section 87 is a processing section which determines whether the HTTP request is to be transmitted to the Web server 40 based on the estimation result received from the second estimation section 85 and on a predetermined determination rule 87a, and which outputs this determination result to the transmitter 88. Specifically, if receiving the estimation result that the HTTP request is an illegal request from the second estimation section 85, the second determination section 87 determines that the HTTP request is not to be transmitted to the Web server 40 (reject determination). If receiving the estimation result that the HTTP request is a legal request from the second estimation section 85, the second determination section 87 determines that the HTTP request is to be transmitted to the Web server 40 (approval determination).

The transmitter 88 is an access request transmission unit which controls the transmission of the HTTP request received from the receiver 31 based on the determination result(s) received from at least one of the first determination section 84 and the second determination section 87. Specifically, if receiving the approval determination from the second determination section 87, the transmitter 88 transmits the HTTP request to the Web server 40 over inter-process communication. If receiving the reject determination from the first determination section 84 or the second determination section 87, the transmitter 88 rejects the transmission of the HTTP request to the Web server 40 and abandons this illegal request.

That is, the transmitter 88 transmits only the HTTP request, as a legal HTTP request, which is determined to be transmitted to the web server 40 by the first determination section 84 and the second determination section 87, to the Web server 40. Specifically, this HTTP request is not considered to be an illegal request from the request contents thereof and is not considered to be an illegal request from the statistic of the HTTP requests to the Web server 40).

Although not shown in FIG. 7, the request filter 81 in the fourth embodiment also includes the log management section, external notification section, external information acquisition section, and the update section as in the instance of the request filter 30 in the first embodiment. That is, the log management section in the request filter 81 in the fourth embodiment, as in the instance of the request filter 30 in the first embodiment, stores information on the HTTP request which is not transmitted to the Web server 40 by the transmitter 88 based on a predetermined rule in a specific storage medium and manages the stored information.

In addition, the external notification section informs an external device of the information on the HTTP request which is not transmitted to the Web server 40 by the transmitter 88 based on a predetermined notification rule. The external information acquisition section actively or passively acquires information used for the update processing of the update section from the outside of the request filter 81 such as the external device or the Web server 40 based on a predetermined acquisition rule.

The update section updates information stored in the illegal request DB 33, estimation rule 32a, determination rule 34a, estimation rule 85a, determination rule 87a, management rule, notification rule, acquisition rule, or a predetermined update rule, based on the predetermined update rule. The update section also updates the information stored in the statistically illegal request DB 86 based on the predetermined update rule and on the statistic of access requests to the Web server 40.

(2) Filtering Processing

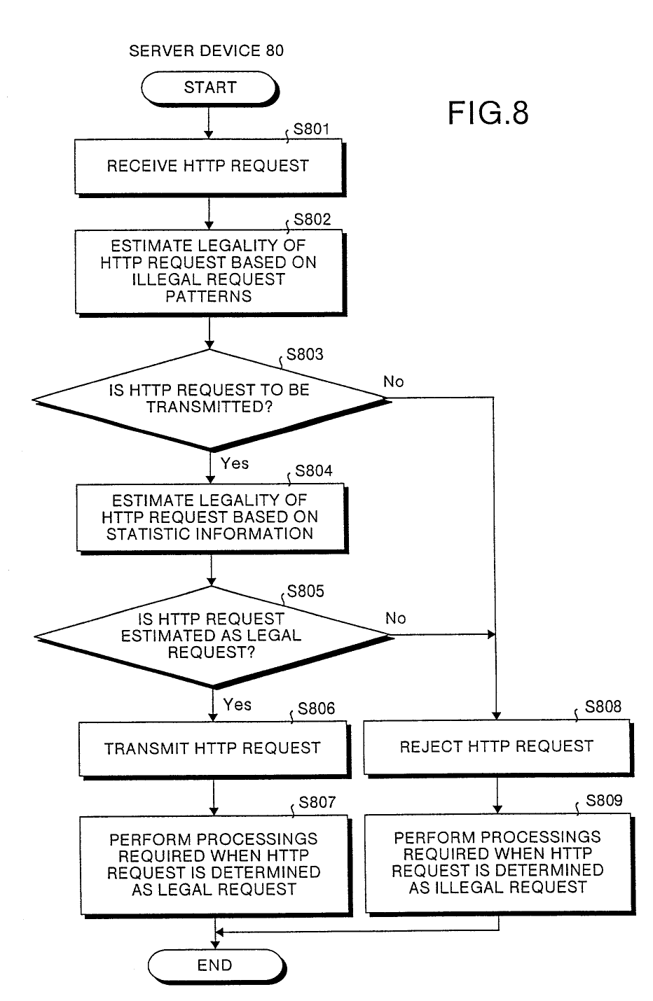

Filtering processing procedures in the fourth embodiment will be explained. FIG. 8 is a flow chart which explains the filtering processing procedures in the fourth embodiment. As shown in this figure, the receiver 31 of the request filter 81 in the server device 80 receives an HTTP request from each client device 10 before the Web server 40 receives (step S801).

The request filter 81 transmits the HTTP request to the first estimation section 82 to execute the same processing as the filtering processing in the first or second embodiment, i.e., the pattern-based filtering processing (steps S802, S803, S808 and S809).

That is, the first estimation section 82 estimates the legality of the HTTP request based on the patterns of illegal accesses to the server stored in the illegal request DB 83 (step S802). The first determination section 84 determines whether the HTTP request is to be transmitted to the Web server 40, i.e., whether the HTTP request is estimated as a legal request or whether the estimation value DI thereof is not higher than a predetermined threshold value (step S803).

If it is determined by the first determination section 84 that the HTTP request is not to be transmitted to the Web server 40, i.e., the HTTP request is estimated as an illegal request or the estimation value DI thereof is not lower than the predetermined threshold value (“No” at step S803), then the transmitter 88 rejects the transmission of the HTTP request to the Web server 40 (step S808). The respective sections of the request filter 81 perform processings required when an HTTP request is determined to be an illegal request, including the abandonment of the illegal request, the storage of information on the illegal request in the storage medium, the notification of the information on the illegal request to the external device and the like (step S809).

Conversely, if it is determined by the first determination section 84 that the HTTP request is to be transmitted to the Web server 40, i.e., the HTTP request is estimated as a legal request or the estimation value DI thereof is not higher than the predetermined threshold (“Yes” at step S803), then the HTTP request is output to the second estimation section 85 to execute the filtering processing based on the statistic of the HTTP requests to the server. The second estimation section 85 estimates the legality of the HTTP request based on the statistic information stored in the statistically illegal request DB 86 and on the predetermined estimation rule 85a (step S804).

Specifically, if the transmitting end information on the HTTP request corresponds to any one of the transmitting end information stored in the statistically illegal request DB 86 or the request content thereof corresponds to any one of the request contents stored in the statistically illegal request DB 86, then the second estimation section 85 estimates that the HTTP request is an illegal request. If the transmitting end information on the HTTP request does not correspond to any transmitting end information stored in the statistically illegal request DB 86 or the request content thereof does not correspond to any request contents stored in the statistically illegal request DB 86, then the second estimation section 85 estimates that the HTTP request is a legal request.

The second determination section 87 determines whether the HTTP request is to be transmitted to the Web server 40, i.e., whether the HTTP request is estimated as a legal request based on the estimation result received from the second estimation section 85 and on the predetermined estimation rule 87a (step S805).

If it is determined by the second determination section 87 that the HTTP request is estimated as a legal request (“Yes” at step S805), the transmitter 88 transmits the HTTP request to the Web server 40 over inter-process communication (step S806). The Web server 40 performs processings required when an HTTP request is determined to be a legal request, including the transmission of information according to the HTTP request to the client device 10 (step S807).

Conversely, if it is determined by the second determination section 87 that the HTTP request is estimated as an illegal request (“No” at step S805), the transmitter 88 rejects the transmission of the HTTP request to the Web server 40 (step S808). The respective sections of the request filter 81 perform processings required when an HTTP request is determined to be an illegal request, including the abandonment of the illegal request, the storage of information on the illegal request in the storage medium, the notification of the information on the illegal request to the external device and the like (step S809).

Through a series of processings explained above, only the HTTP request, which is not considered to be an illegal request from the request content thereof and which is not considered to be an illegal request from the statistic of the HTTP requests to the Web server 40, is transmitted as a legal HTTP request to the Web server 40.

As explained above, according to the fourth embodiment, the legality of the HTTP request is estimated while referring to the illegal request DB 83 which stores the patterns of the illegal accesses to the server and also referring to the statistically illegal request DB 86 which stores information on the access requests considered to be illegal accesses based on the statistic of the access requests to the server. It is, therefore, possible to abandon not only the access request which is considered to be an illegal access from the request content thereof but also the access request which is considered to be an illegal access based on the statistic of the access requests to the server. As a result, it is possible to further ensure protecting the Web server 40 from illegal accesses by the client devices 10.

(3) Modification of Fourth Embodiment

As explained in the fourth embodiment so far, this invention can be executed by various modifications other than the fourth embodiment within the scope of the technical concept of claims which follow.

In the fourth embodiment, for example, the instance in which the statistically illegal request DB 86 stores the predetermined transmitting end information and request contents has been explained. However, this invention is not limited to this instance but is applicable to an instance in which the statistically illegal request DB 86 stores either the predetermined transmitting end information or the predetermined request contents.

That is, if the statistically illegal request DB 86 stores only the predetermined transmitting end information, the second estimation section 85 estimates that the HTTP request is an illegal access under the conditions that the transmitting end information on the HTTP request corresponds to any one of the transmitting end information stored in the statistically illegal request DB 86, and estimates that the HTTP request is a legal access under the conditions that the transmitting end information on the HTTP request does not correspond to any transmitting end information stored in the statistically illegal request DB 86.

On the other hand, if the statistically illegal request DB 86 stores only the predetermined request contents, the second estimation section 85 estimates that the HTTP request is an illegal access under the conditions that the request content of the HTTP request corresponds to any one of the request contents stored in the statistically illegal request DB 86, and estimates that the HTTP request is a legal access under the conditions that the request content of the HTTP request does not correspond to any request contents stored in the statistically illegal request DB 86.

Further, in the fourth embodiment, the instance of determining whether the HTTP request is an illegal access according to whether the transmitting end information on the HTTP request or the request content thereof corresponds to any one of the predetermined transmitting end information or request contents stored in the statistically illegal request DB 86 has been explained. However, this invention is not limited to the embodiment but is also applicable to an instance of determining whether the HTTP request is an illegal access according to a degree to which the HTTP request corresponds to any one of the predetermined transmitting end information or request contents stored in the statistically illegal request DB 86.

That is, in this instance, as in the instance of the second embodiment, a danger index is allocated to each of the predetermined transmitting end information and request contents stored in the statistically illegal request DB 86. The second estimation section 85 calculates an estimation value referred to as a DI (Danger Index) indicating the degree of the danger of the HTTP request using respective danger indexes corresponding to the transmitting end information and request contents of HTTP requests. The second determination section 87 compares the estimation value DI thus calculated with a predetermined threshold value and determines whether the HTTP request is an illegal access.

Furthermore, in the fourth embodiment, the instance in which the second estimation section 85 estimates the legality of only the HTTP request which is determined by the first determination section 84 that the HTTP request is to be transmitted to the Web server 40 has been explained. That is, the instance in which a pattern-based filtering processing is executed and then a statistic-based filtering processing is executed, has been explained. However, this invention is not limited to this instance.

For example, this invention is also applicable to an instance in which the first estimation section 82 estimates the legality of only the HTTP request which is determined by the second determination section 87 that the HTTP request is to be transmitted to the Web server 40. In this instance, after the statistic-based filtering processing is executed, the pattern-based filtering processing is executed.

In addition, this invention is applicable to an instance in which the predetermination processing explained in the third embodiment, for example, is added and the predetermination section conducts a predetermination processing to only the access request which is determined to be transmitted to the Web server 40 by the second determination section 87. In this instance, after the statistic-based filtering processing is executed, the predetermination processing is executed and then a pattern-based filtering processing is executed.

If the predetermination processing is added, it is necessary to conduct the predetermination processing after the statistic-based filtering processing for the following reason. If the predetermination processing is conducted before the statistic-based filtering processing, the HTTP request may possibly be determined to correspond to any one of the legal access patterns stored in the legal pattern database and transmitted to the Web server 40 without being abandoned by the statistic-based filtering processing.

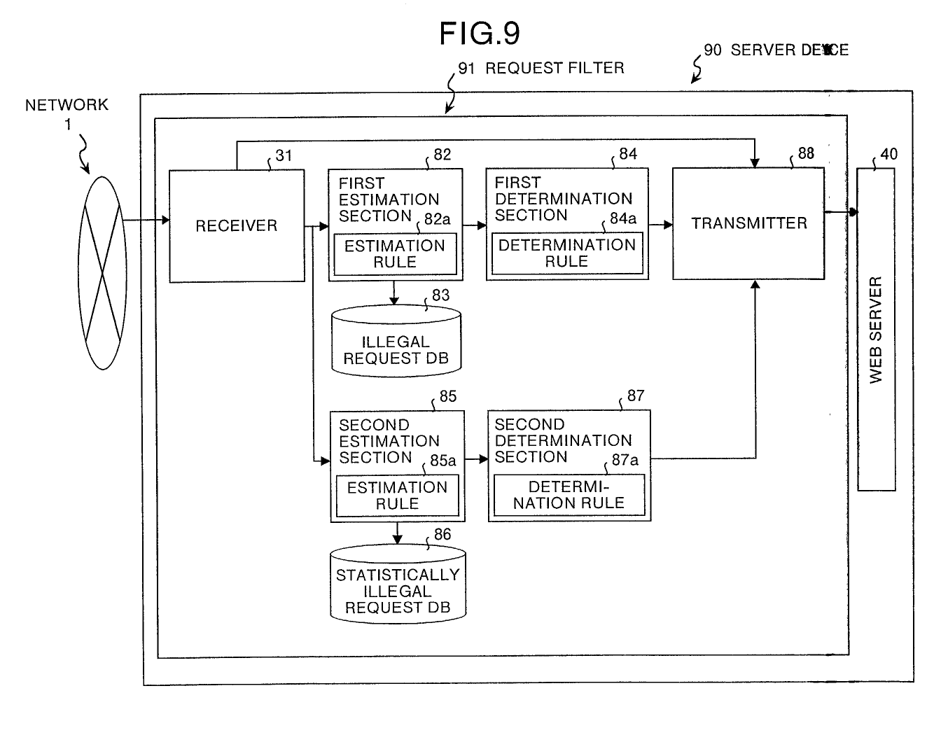

Moreover, this invention is not limited to an instance of hierarchically executing the pattern-based filtering processing and the statistic-based filtering processing but is also applicable to an instance of executing these processings in parallel. That is, as shown in FIG. 9, the request filter 91 of a server device 90 includes the first estimation section 82 and first determination section 84, which execute a pattern-based filtering processing, and the second estimation section 85 and second determination section 87, which execute a statistic-based filtering processing, provided between the receiver 31 and the transmitter 88 in parallel. By thus constituting the request filter 91, it is possible to determine further promptly whether the HTTP request is an illegal access.

A fifth embodiment of this invention will be explained below. In the fourth embodiment, the instance of executing the statistic-based filtering processing while referring to the statistically illegal request DB 86 has been explained. However, this invention is also applicable to an instance of executing a filtering processing while dynamically updating information stored in this statistically illegal request DB 86.

That is, in the fourth embodiment, the second estimation section 85 estimates that the HTTP request is an illegal request if transmitting end information on the HTTP request corresponds to any one of the transmitting end information stored in the statistically illegal request DB 86 or the request content thereof corresponds to any one of the request contents stored in the statistically illegal request DB 86.

However, there occurs an instance in which the number of received HTTP requests from a specific client device 10 (transmitting end information) and the number of received HTTP requests of a specific request content, sharply increase. In this instance, if at least one of the specific transmitting end information and the specific request content is not added to the statistically illegal request DB 86 in a real-time manner, the HTTP request which is considered to be an illegal request based on the statistic of the HTTP requests to the server may possibly be transmitted to the Web server 40.

On the other hand, there occurs an instance in which at least one of the number of received transmitting end information and the number of received HTTP requests of a specific request content stored in the statistically illegal request DB 86 decreases. In this instance, if at least one of the specific transmitting end information and the specific request content is not deleted from the statistically illegal request DB 86 in a real-time manner, even the HTTP request which is not considered to be an illegal access based on the statistic of the HTTP requests to the sever may possibly be abandoned.

The fifth embodiment is therefore configured to dynamically update information stored in the statistically illegal request DB 86 to thereby make it possible to accurately, surely abandon an HTTP request which is considered to be an illegal request based on the statistic of HTTP requests to the server. The configuration of a server device in a server-client system in the fifth embodiment will be explained.

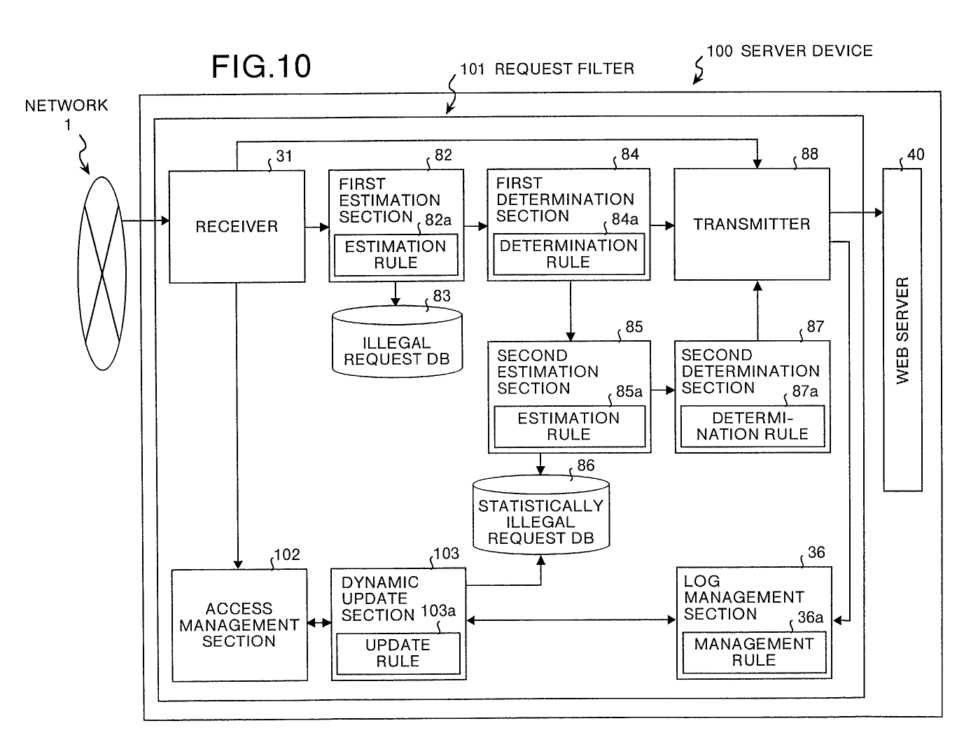

FIG. 10 is a block diagram which shows the configuration of the server-client system in the fifth embodiment. In this figure, sections having the same functions as those shown in FIG. 1 or 7 are denoted by the same reference symbols and will not be explained in detail herein. An access management section 102 and a dynamic update section 103 which are the characteristic parts of the fifth embodiment will be explained.

The access management section 102 of a request filter 101 provided in a server device 100 is a memory which manages, as a history, transmitting end information on HTTP requests transmitted to the server device 100, request contents and transmission time of the HTTP requests.

The dynamic update section 103 is a processing section which dynamically updates information stored in the statistically illegal request DB 86 based on the information managed by the access management section 102 and on a predetermined update rule 103a. Specifically, if the number of HTTP requests transmitted to the Web server 40 from a specific client device 10 within a predetermined time exceeds a predetermined upper limit number, the dynamic update section 103 adds transmitting end information on the HTTP requests to the statistically illegal request DB 86 while referring to the access management section 102.

On the other hand, if the number of HTTP requests transmitted to the Web server 40 from a client device 10 included in the transmitting end information stored in the statistically illegal request DB 86 within a predetermined time falls under a predetermined lower limit number, the dynamic update section 103 deletes the transmitting end information from the statistically illegal request DB 86.

Further, if the number of specific HTTP requests transmitted to the Web server 40 exceeds the predetermined upper limit number within a predetermined time, the dynamic update section 103 adds the request contents of the HTTP request to the statistically illegal request DB 86 while referring to the access management section 102. If the number of HTTP requests having the request contents stored in the statistically illegal request DB 86 falls under the predetermined upper limit number within the predetermined time, the dynamic update section 103 deletes the request contents from the statistically illegal request DB 86.

The “predetermined upper limit number” is a threshold value for which HTTP requests are to be considered to be illegal accesses intended at server down if the number of the HTTP requests exceeds the threshold value. The “predetermined lower limit number” is a threshold value for which HTTP requests are not to be considered to be illegal accesses if the number of the HTTP requests falls under the threshold value. The upper and lower limit numbers are set according to the processing capability and the like of the Web server 40.

As explained above, according to the fifth embodiment, the transmitting end information and the request contents stored in the statistically illegal request DB 86 are added or deleted according to the number of HTTP requests from each client device 10 which transmits the HTTP requests to the Web server 40 within the predetermined time, or to the number of HTTP requests of the same request content transmitted to the Web server 40 within the predetermined time. It is, therefore, possible to accurately, more surely abandon the HTTP request which is considered to be an illegal request based on the statistic of the HTTP requests to the Web server 40.

In the fifth embodiment, the instance of updating both the transmitting end information and the request contents stored in the statistically illegal request DB 86 has been explained. However, this invention is not limited to this instance. If either the transmitting end information or the request contents are stored in the statistically illegal request DB 86, the transmitting end information or the request contents can be updated by adding or deleting only the transmitting end information or the request contents in accordance with the information stored in the statistically illegal request DB 86.

Furthermore, in the fifth embodiment, the instance of dynamically updating the statistically illegal request DB 86 while referring only to the access management section 102 has been explained. However, this invention is not limited to this instance but is also applicable to an instance of dynamically updating the statistically illegal request DB 86 while referring to, for example, both the log management section 36 and the access management section 102.

That is, the transmitting end information added to the log management section 36 can be also added to the statistically illegal request DB 86. The transmitting end information stored in the log management section 36 can be each allocated a high danger index in the statistically illegal request DB 86. In addition, even if the number of requests falls under the lower limit value, the requests are not deleted from the statistically illegal request DB 86. In this way, it is possible to dynamically update the statistically illegal request DB 86 while referring to the log management section 36.

A sixth embodiment of this invention will be explained below. In the first to fifth embodiments, the instance of estimating the HTTP request transmitted from each client device 10 in various manners and abandoning the illegal access has been explained. However, this invention is not limited to this instance but is also applicable to an instance of estimating the legality of even a response transmitted from the Web server 40 to each client device 10 in accordance with the HTTP request and abandoning the response if the response is estimated as an illegal response.

That is, in the first to fifth embodiments, the illegal request patterns are stored in the illegal request DB 33 or the like, it is determined whether the HTTP request from each client device 10 is an illegal access according to whether the HTTP request corresponds to anyone of the illegal request patterns. It is sometimes difficult to describe some illegal request as patterns. These requests involve, for example, an illegal access which is intended to receive, as a response, secret information, such as directory information, which should not be leaked to the outside of the Web server 40, by transmitting an HTTP request which requests a file which does not exist on the Web server 40.

Since such an illegal access is to request a file which does not exist on the Web server 40 and the illegal access is difficult to describe as a pattern, the request cannot be determined as an illegal access only by estimating whether the request coincides with one of the illegal request patterns. On the other hand, a response transmitted from the Web server 40 to the client device 10 in accordance with such an illegal access includes the secret information such as directory information which should not be leaked to the outside of the Web server 40. By estimating whether the secret information is included in the response, it is considered that the illegal response difficult to describe as a pattern can be dealt with.

The sixth embodiment is therefore configured to estimate the legality of a response while referring to a database storing the patterns of illegal responses which should not be transmitted to client devices 10, and thereby to make it possible to abandon even an illegal response to be transmitted to each client device 10 in accordance with the illegal access which is difficult to describe as a pattern. The configuration of a server device in a server-client system in the sixth embodiment and filtering processing procedures in the sixth embodiment will be explained below.

(1) Configuration of Server Device

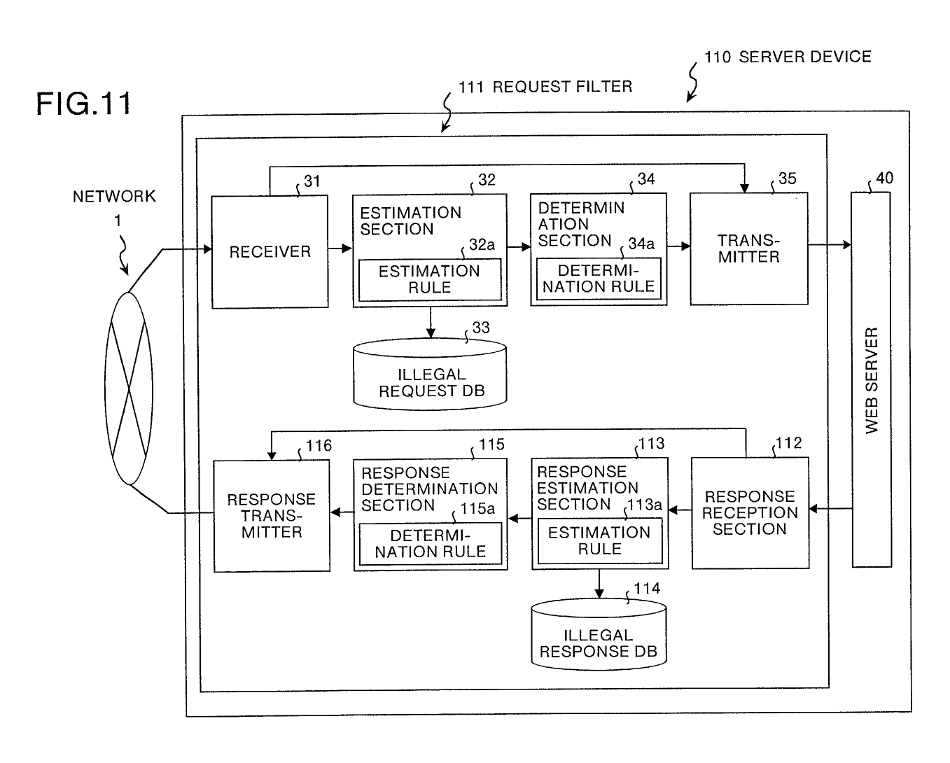

The configuration of the server device in the server-client system in the sixth embodiment will be explained. FIG. 11 is a block diagram which shows the configuration of the server-client system in the sixth embodiment. As shown in this figure, the server device 110 in the sixth embodiment includes the Web server 40 and request filter 111. The request filter 111 includes the receiver 31, estimation section 32, illegal request DB 33, determination section 34, transmitter 35, response receiving section 112, response estimation section 113, illegal response DB 114, response determination section 115, and the response transmission section 116.

Among these constituent sections, the receiver 31, estimation section 32, illegal request DB 33, determination section 34, and the transmitter 35 have the same functions as those denoted by the same reference symbols in FIG. 1, respectively. These sections execute the same processing as the filtering processing in the first or second embodiment, i.e., the pattern-based filtering processing.

An HTTP request, which is difficult to describe as a pattern such as an HTTP request which requests a file not existing on the Web server 40, is not stored as a pattern in the illegal request DB 33. Therefore, the HTTP request is not abandoned as an illegal request and transmitted to the Web server according to the illegal request. However, a response to be transmitted from the Web server 40 to the client device 10 in accordance with the illegal request is abandoned as an illegal response by the processings of the respective sections to be explained later.

The response receiving section 112 is a processing section which receives a response from the Web server 40 before the response is transmitted to each client device 10. The response received by the response receiving section 112 from the Web server 40 is output to the response estimation section 113 and the response transmission section 116.

The response estimation section 113 is a processing section which estimates the legality of a response based on illegal response patterns stored in the illegal response DB 114 and on a predetermined estimation rule 113a, and which outputs the estimation result to the response determination section 115.

The illegal response DB 114 is a database which stores the patterns of illegal responses which should not be transmitted to each client device 10 among responses transmitted from the Web server 40 to the client devices 10 in accordance with the HTTP request. Specifically, the illegal response DB 114 stores secret information such as directory information which should not be leaked to the outside of the Web server 40 as patterns.

The illegal response DB 114 stores the secret information as patterns because there is a probability that the secret information is transmitted to each client device 10 as a response to an HTTP request which requests a file not existing on the Web server 40.

The response estimation section 113 estimates the legality of the response based on the predetermined estimation rule 113a while referring to the illegal response DB 114 which stores such secrete information. Specifically, if the response corresponds to any one of the secrete information patterns stored in the illegal response DB 114, the response estimation section 113 estimates that the response is an illegal response. If the response does not correspond to any one of the secrete information patterns stored in the illegal response DB 114, the response estimation section 113 estimates that the response is a legal response.

The response determination section 115 is a processing section which determines whether the response is to be transmitted to the client device 10 based on the estimation result received from the response estimation section 113 and on a predetermined determination rule 115a, and which outputs the determination result to the response transmission section 116. Specifically, if receiving the estimation result that the response is an illegal response from the response estimation section 113, the response determination section 115 determines that the response is not to be transmitted to the client device 10 (reject determination). If receiving the estimation result that the response is a legal response from the response estimation section 113, the response determination section 115 determines that the response is to be transmitted to the client device 10 (approval determination).

The response transmission section 116 is a processing section which controls the transmission of the response received from the response receiving section 112 based on the determination result of the response determination section 115. Specifically, if receiving the approval determination from the response determination section 115, the response transmission section 116 transmits the response to the client device 10 through a network 1. If receiving the reject determination from the response determination section 115, the response transmission section 116 rejects the transmission of the response to the client device 10 and abandons this response as an illegal response.

Although not shown in FIG. 11, the request filter 111 in the sixth embodiment also includes the log management section, external notification section, external information acquisition section, and the update section as in the instance of the request filter 30 in the first embodiment shown in FIG. 1. That is, in the request filter 111 in the sixth embodiment as in the instance of the request filter 30 in the first embodiment, the log management section stores information on the response which is not transmitted to the client device 10 by the response transmission section 116 and information on HTTP requests causing the response in a predetermined storage medium and manages the responses.

The external notification section notifies an external device of information on the response which is not transmitted to the client device 10 by the response transmission section 116 and information on the HTTP request causing this response based on the predetermined notification rule. The external information acquisition section actively or passively acquires information used in the update processing of the update section from the outside of the request filter 111 such as the external device or the Web server 40 based on the predetermined acquisition rule.

The update section updates information stored in the illegal response DB 114, estimation rule 113a, determination rule 115a, management rule, notification rule, acquisition rule, or a predetermined update rule based on the predetermined update rule. For example, if receiving a new illegal response pattern from the external information acquisition section, the update section stores this illegal response pattern in the illegal response DB 114. If receiving the change instruction information on the estimation rule 113a, the update section changes the estimation rule 113a in accordance with this change instruction information.

(2) Filtering Processing

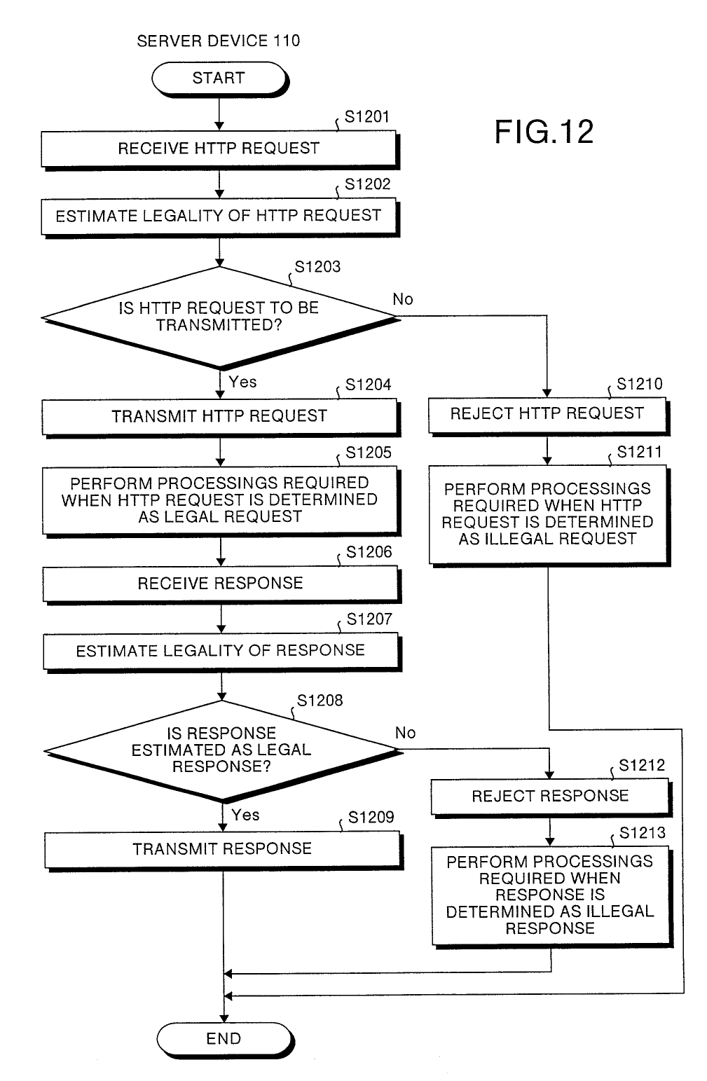

Filtering processing procedures in the sixth embodiment will be explained below. FIG. 12 is a flow chart which explains the filtering processing procedures in the sixth embodiment. As shown in this figure, the receiver 31 of the request filter 111 in the server device 110 receives an HTTP request from each client device 10 before the Web server 40 receives (step S1201).

The request filter 111 transmits this HTTP request to the estimation section 32 to execute the same processing as the filtering processing in the first or second embodiment, i.e., the pattern-based filtering processing (steps S1202 to S1205, S1210 and S1211).

That is, the estimation section 32 estimates the legality of the HTTP request based on the patterns of the illegal accesses to the server stored in the illegal request DB 33 (step S1202) The determination section 34 determines whether the HTTP request is to be transmitted to the Web server 40, i.e., whether the HTTP request is estimated as a legal request or whether the estimate ID of the HTTP request is not higher than a predetermined threshold value (step S1203)

If it is determined by the determination section 34 that the HTTP request is not to be transmitted to the Web server 40, i.e., the HTTP request is estimated as an illegal request or the estimate ID of the HTTP request is not lower than the predetermined threshold value (“No” at step S1203), then the transmitter 35 rejects the transmission of the HTTP request to the Web server 40 (step S1210). In addition, the respective sections of the request filter 111 perform processings required when an HTTP request is determined as an illegal request, including the abandonment of the illegal request, the storage of information on the illegal request in a storage medium, the notification of the information on the illegal request to the external device and the like (step S1211).

Conversely, if it is estimated that the HTTP request is a legal request (“Yes” at step S1203), the transmitter 35 transmits the HTTP request to the Web server 40 over inter-process communication (step S1204). The Web server 40 performs processings required when an HTTP request is determined as a legal request, including the creation of a response in accordance with the HTTP request (step S1205).

The response receiving section 112 of the request filter 111 receives a response from the Web server 40 (step S1206). The response estimation section 113 estimates the legality of the response based on the secret information patterns stored in the illegal response DB 114 and the predetermined estimation rule 113a (step S1207) Specifically, if the response corresponds to any one of the illegal response patterns stored in the illegal response DB 114, the response estimation section 113 estimates that the response is an illegal response. If the response does not correspond to any of the illegal response patterns stored in the illegal response DB 114, the response estimation section 113 estimates that the response is a legal response.

The response determination section 115 determines whether the response is to be transmitted to the client device 10 based on the estimation result received from the response estimation section 113 and the predetermined determination rule 115a (step S1208). Specifically, the response determination section 115 determines whether the response is estimated as a legal response.

If it is determined by the response determination section 115 that the response is estimated as a legal response (“Yes” at step S1208), the response transmission section 116 transmits the response to the client device 10 through the network 1 (step S1209).

Conversely, it is determined by the response determination section 115 that the response is estimated as an illegal response (“No” at step S1208), the response transmission section 116 rejects the transmission of the response to the client device 10 (step S1212). The respective sections of the request filter 111 perform processings required when a response is determined as an illegal response, including the abandonment of the illegal response, the storage of information on the illegal response in a storage medium, the notification of information on the illegal response to the external device and the like (step S1213).

Through a series of the above-mentioned processings, only the legal response in accordance with the legal access, i.e., only the response which is not abandoned as an illegal response in accordance with the access which is not abandoned as an illegal access, is transmitted to each client device 10.

As explained above, according to the sixth embodiment, the HTTP request transmitted from each client device 10 is estimated in various manners and the illegal access is abandoned. In addition, the legality of the response transmitted to each client device 10 from the Web server 40 in accordance with the HTTP request is also estimated and the illegal response is abandoned. It is, therefore, possible to abandon not only the illegal access described as the illegal access pattern but also an illegal response in accordance with the illegal access which is difficult to describe as an illegal access pattern. As a result, it is possible to further ensure protecting the Web server 40 from the illegal access of each client device 10.

(3) Modification of Sixth Embodiment

While the sixth embodiment has been explained above, this invention may be carried out by various embodiments other than the sixth embodiment within the scope of the technical concept according to the claims which follow.

For example, in the sixth embodiment, the instance of determining whether the response from the Web server 40 is an illegal response according to whether the response corresponds to any one of the illegal response patterns stored in the illegal response DB 114 has been explained. However, this invention is not limited to this instance but is also applicable to an instance of determining whether the response is an illegal access in accordance with a degree to which the response corresponds to any one of the illegal response patterns stored in the illegal response DB 114.

That is, in this instance, as in the instance of the second embodiment, the response estimation section 113 calculates an estimation value referred to as a DI (Danger Index) indicating the danger degree of a response by calculating the number of patterns, among the illegal response patterns stored in the illegal response DB 114, which correspond to the response or by allocating a danger index to each pattern and calculating the danger index of the pattern corresponding to the response. The response determination section 115 compares the estimation value thus calculated with a predetermined threshold value and determines whether the response is to be transmitted to the client device 10.

In the sixth embodiment, the instance of executing the pattern-based filtering processing to the HTTP request transmitted from each client device 10 has been explained. However, this invention is not limited to this instance but is also applicable to an instance of executing the predetermination processing explained in the third embodiment or the statistic-based filtering processing explained in the fourth embodiment as well as the pattern-based filtering processing.

A seventh embodiment of this invention will be explained below. In the first to sixth embodiments, the instance of executing the filtering processing to the HTTP request which is not encrypted and to the response which is not encrypted has been explained. However, this invention is not limited to this instance but is also applicable to an instance of executing a filtering processing to an HTTP request which is encrypted and to a response which is encrypted.

That is, in the first to sixth embodiments, it is premised that the Web server 40 receives an unencrypted HTTP request from each client device 10 and transmits an unencrypted response to the client device 10. However, some Web server 40 receives an encrypted HTTP request from each client device 10 and transmits an encrypted response to the client device 10 so as to secure the secrecy of a service to be provided to the client device 10.

If the filtering processing explained in the first to sixth embodiments is simply applied to such a Web server 40, an encrypted illegal access and an encrypted illegal response cannot be abandoned. As a result, the Web server 40 cannot be protected from illegal accesses. In addition, there is a probability that an illegal response is transmitted from the Web server 40 to the client device 10.

The seventh embodiment is therefore configured to decrypt an HTTP request and a response each of which has been encrypted, and thereby to make it possible to abandon the encrypted illegal access and the encrypted illegal response. The configuration of a server device in a server-client system in the seventh embodiment will be explained hereinafter.

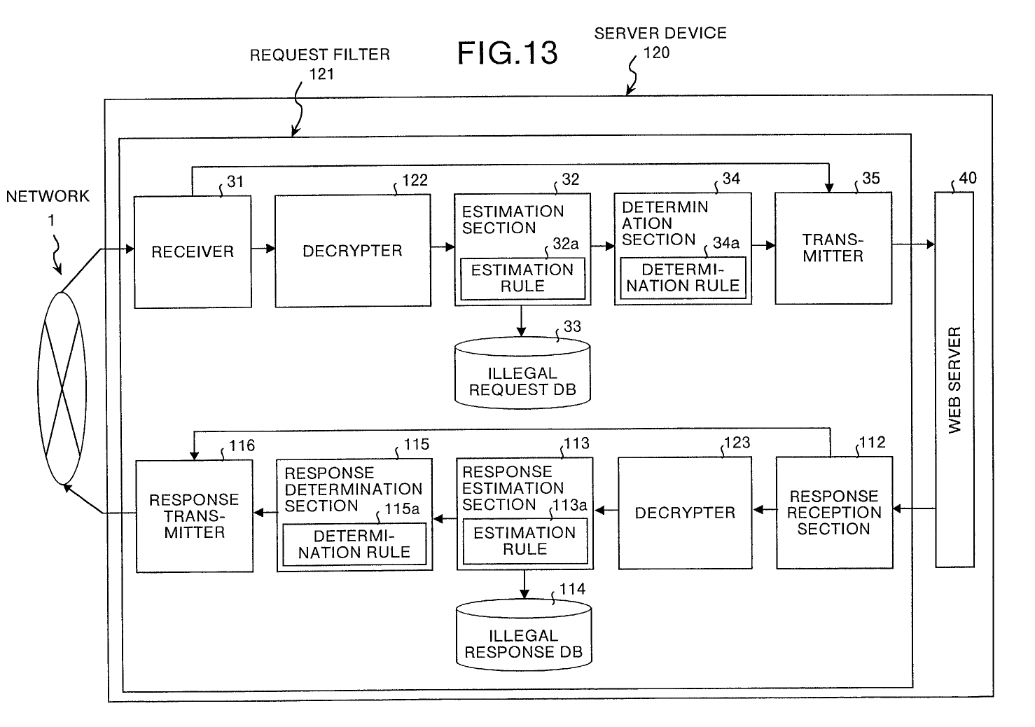

FIG. 13 is a block diagram which shows the configuration of the server-client system in the seventh embodiment. In this figure, sections having the same functions as those shown in FIG. 1 or 11 are denoted by the same reference symbols and will not be explained in detail. Decrypters 122 and 123 which are the characteristic parts of the seventh embodiment will be explained.

The decrypter 122 of a request filter 121 in a server device 120 is a decryption unit which decrypts an HTTP request which has been subjected to a predetermined encryption processing. Specifically, after receiving an encrypted HTTP request from the receiver 31, the decrypter 122 decrypts this HTTP request and outputs the decrypted HTTP request to the estimation section 32. The estimation section 32 executes the estimate processing explained in the first or second embodiment.

Since the receiver 31 outputs the encrypted HTTP request to the transmitter 35, the encrypted HTTP request is transmitted to the Web server 40. As a result, a plurality of Web servers 40 are protected by one request filter 121. Therefore, even if the request filter 121 is connected to a plurality of Web servers 40 through a non-dedicated line such as the Internet, it is possible to secure the secrecy of the HTTP request.

The decrypter 123 is a second decryption unit which decrypts a response which has been subjected to a predetermined encryption processing. Specifically, after receiving an encrypted response from the response receiving section 112, the decrypter 123 decrypts this response and outputs the decrypted response to the response estimation section 113. The response estimation section 113 executes the estimate processing explained in the sixth embodiment.

Since the response receiving section 112 outputs the encrypted response to the response transmission section 116, the encrypted response is transmitted to each client device 10. It is, therefore, possible to secure the secrecy of the response transmitted to the client device 10.

As explained above, according to the seventh embodiment, the encrypted HTTP request is decrypted and the encrypted response is decrypted, as well. Therefore, even if this invention is applied to the Web server 40 which receives an encrypted HTTP request from each client device 10 and transmits an encrypted response to the client device 10, it is possible to abandon the encrypted illegal access and the encrypted illegal response. It is also possible to ensure protecting the Web server 40 from illegal accesses and further ensure eliminating the probability that an illegal response is transmitted from the Web server 40 to each client 10.

In the seventh embodiment, the instance of decrypting the HTTP request and the response has been explained. However, this invention is not limited to this instance but is also applicable to an instance of decrypting either an HTTP request or a response according to the condition of a processing mode of the Web server 40, i.e., according to whether the Web server 40 is to receive the encrypted HTTP request or whether the Web server 40 is to transmit the encrypted response).

Furthermore, in the seventh embodiment, the instance of decrypting the HTTP request by the request filter 121 and then transmitting the encrypted HTTP request to the Web server 40 has been explained. However, this invention is not limited to this instance but is also applicable to an instance of transmitting a decrypted HTTP request to the Web server 40. In this instance, it is possible to dispense with the decryption units of the Web server 40.

Moreover, in the seventh embodiment, the instance of executing the pattern-based filtering processing to the HTTP request transmitted from each client device 10 has been explained. However, this invention is not limited to this instance but is also applicable to the instance of executing the predetermination processing explained in the third embodiment or the statistic-based filtering processing explained in the fourth embodiment as well as the pattern-based filtering processing. In this instance, as in the instance of the third or fourth embodiment, the decrypting processings explained in the seventh embodiment are executed before the predetermination processing or the statistic-based filtering processing.

An eighth embodiment of this invention will be explained below, In the first to seventh embodiments, the instance of abandoning the illegal HTTP request and illegal response has been explained. However, this invention is not limited to this instance but is also applicable to an instance of transmitting a pseudo-response indicating that an illegal access is successful or successfully proceeding to each client device 10.

That is, there is a probability that a cracker who tries to illegally access the Web server recognizes the failure of the illegal access and newly tries to illegally access the Web server simply if the illegal HTTP request and the illegal response are abandoned. It is, therefore, preferably necessary to play for time to prevent another new illegal access and to analyze the cracking trick of the cracker without letting the cracker notice the failure of the illegal access.

Meanwhile, there is conventionally, generally known a technique, as a technique of protecting a server from illegal accesses, referred to as a decoy system (decoy server or honey pot). This decoy system pretends to be a fragile server having a security hole or the like and logs all illegal access trials by crackers.

That is, a cracker generally has such a behavior orientation as to attack a server having low security level on the network. Therefore, if the decoy system pretends to be a fragile server and the cracker accesses this decoy system, then the decoy system sends back a login banner as if the server was a true server which is to be protected from illegal accesses. If the cracker tries to log in the server by password cracking or the like using a dictionary, the decoy system safely records all these behaviors as a log.

In this way, the decoy system plays for time before the true server is cracked, prevents another new illegal access, or analyzes the cracking trick of the cracker such as the dictionary used for the cracking. By the analysis result of this cracking trick and playing for time, it is possible to take preventive measures for the true server.

The decoy system has, however, a disadvantage in that the system cannot become the decoy of a true server which is to be protected from illegal accesses. That is, if a certain server is to be protected, a decoy system is normally operated while pretending to be the mirror server or test server of the certain server by being given a name associated with the certain server. This is because it is required to operate the true server while giving the server a name which let a normal user, who normally accesses the true server, recognize the server as a true server.

If the decoy system is introduced so as to protect the true server but the cracker does not care for the decoy system and tries to crack the true server, the function of the decoy system is ignored and the object of protecting the true server cannot be attained.

The eighth embodiment is therefore configured to introduce not a decoy system but a pseudo-response database which stores pseudo-responses each indicating that an illegal access is successful or successfully proceeding to correspond to the patterns of illegal accesses to the Web server 40. It is thereby possible to transmit a pseudo-response indicating that an illegal access is successful or successfully proceeding, to a client device 10 which has tried to illegally access the Web server 40. The configuration of a server device in a server-client system in the eighth embodiment and filtering processing procedures in the eighth embodiment will be explained.

(1) Configuration of Server Device

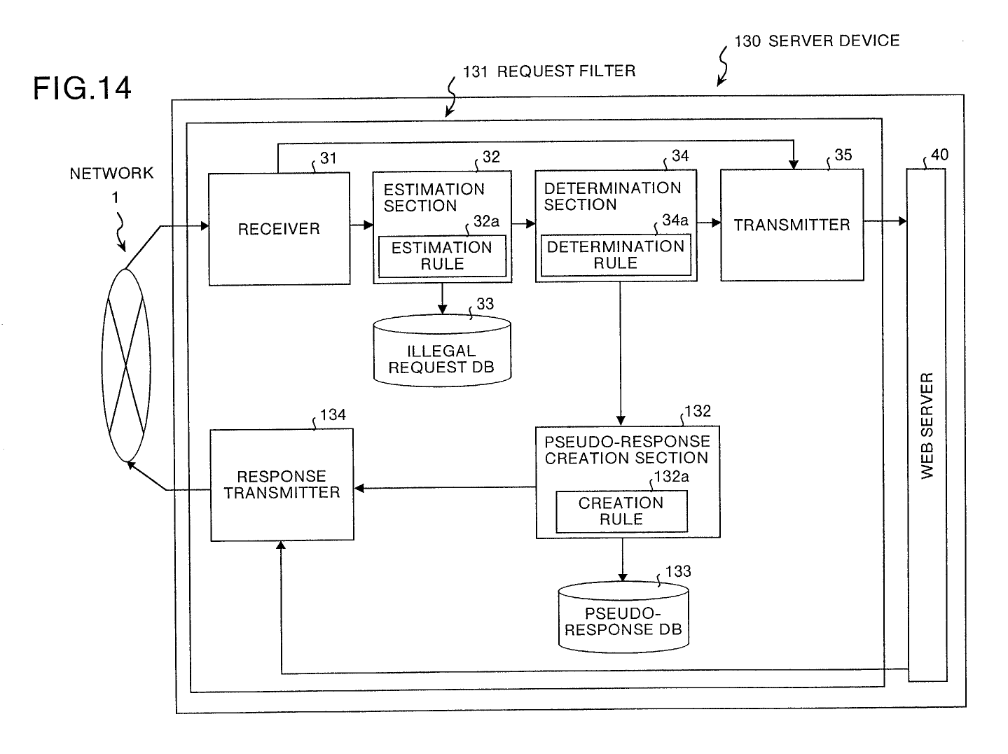

The configuration of a server device in a server-client system in the eighth embodiment will first be explained. FIG. 14 is a block diagram which shows the configuration of a server of a server-client system in the eighth embodiment. As shown in this figure, the server device 130 in the eighth embodiment includes the Web server 40 and request filter 131. The request filter 131 includes the receiver 31, estimation section 32, illegal request DB 33, determination section 34, transmitter 35, pseudo-response creation section 132, pseudo-response DB 133, and the response transmission section 134.

Among these sections, the receiver 31, estimation section 32, illegal request DB 33, determination section 34, and the transmitter 35 have the same functions as those denoted by the same reference symbols shown in FIG. 1, respectively. These sections execute the same processing as the filtering processing shown in the first or second embodiment, i.e., the pattern-based filtering processing. This filtering processing enables an illegal HTTP request not to be transmitted to the Web server 40 but to be output to the pseudo-response creation section 132.

The pseudo-response creation section 132 is a processing section which creates a pseudo-response corresponding to the pattern of an HTTP request that is determined as an illegal request and is not transmitted to the Web server 40 based on the pseudo-response DB 133 and on a predetermined creation rule.

The pseudo-response DB 133 is a database which stores a pseudo-response indicating that an illegal access is successful or successfully proceeding to correspond to the pattern of the illegal access to the Web server 40. Specifically, the pseudo-response DB 133 stores a pseudo-response corresponding to the illegal access pattern stored in the illegal request DB 33. For example, the pseudo-response DB 133 stores a pseudo-password file which corresponds to the pattern of an illegal access to request a password file on the Web server 40 and which consists of unreal information, a pseudo-login banner which corresponds to the pattern of an illegal access to illegally log in the Web server 40 or the like.

The pseudo-response creation section 132 creates a pseudo-response corresponding to the pattern of an HTTP request which is determined as an illegal access and not transmitted to the Web server 40, while referring to the pseudo-response DB 133 which stores such information.

Specifically, if the HTTP request which requests a password file on the Web server 40 is input into the pseudo-response creation section 132 as an illegal access, the pseudo-response creation section 132 creates a pseudo-response using the pseudo-password file stored in the pseudo-response DB 133. If the HTTP request to illegally log in the Web server 40 is input into the pseudo-response creation section 132 as an illegal access, the pseudo-response creation section 132 creates a pseudo-response using the pseudo-login banner stored in the pseudo-response DB 133.

The response transmission section 134 is a processing section which transmits a legal response legally created by the Web server 40 or the pseudo-response created by the pseudo-response creation section 132 to each client device 10. Although not shown in FIG. 14, the request filter 131 in the eighth embodiment also includes the log management section, external notification section, external information acquisition section, and the update section as in the instance of the request filter 30 in the first embodiment shown in FIG. 1.

(2) Filtering Processing

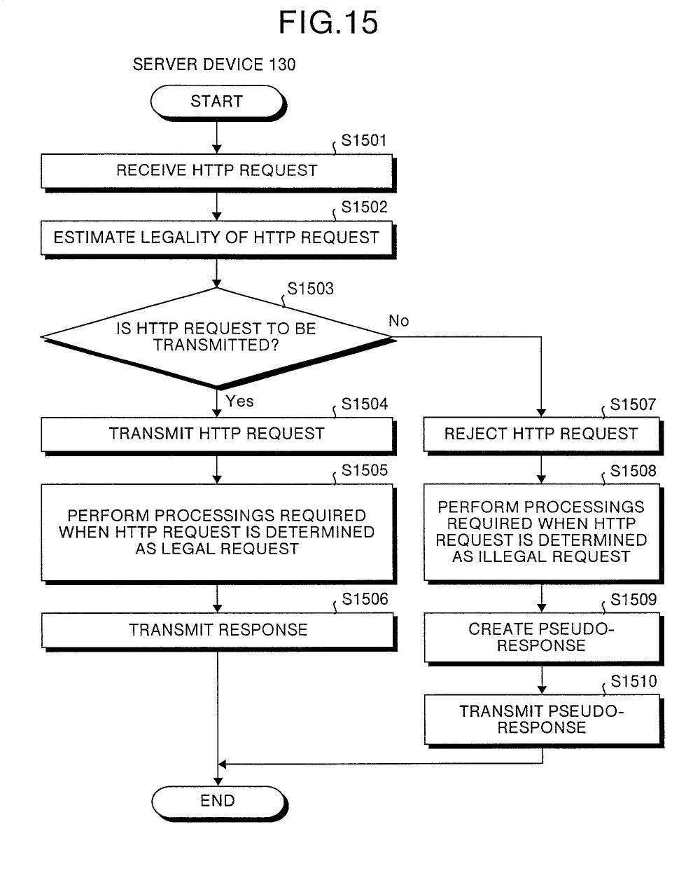

Filtering processing procedures in the eighth embodiment will be explained. FIG. 15 is a flow chart which explains the filtering processing procedures in the eighth embodiment. As shown in the figure, the receiver 31 of the request filter 131 in the server device 130 receives an HTTP request from each client device 10 before the Web server 40 receives (step S1501).

The request filter 131 transmits this HTTP request to the estimation section 32 to perform the same processing as the filtering processing in the first or second embodiment, i.e., the pattern-based filtering processing (steps S1502 to 1505, S1507 and S1508).

That is, the estimation section 32 estimates the legality of the HTTP request based on the patterns of the illegal accesses to the server which are stored in the illegal request DB 33 (step S1502). The determination section 34 determines whether the HTTP request is to be transmitted to the Web server 40, i.e., whether it is estimated that the HTTP request is a legal request or whether the estimation value DI of the HTTP request is not higher than a predetermined threshold value (step S1503).

If it is determined by the determination section 34 that the HTTP request is estimated as a legal request (“Yes” at step S1503), the transmitter 35 transmits the HTTP request to the Web server 40 over inter-process communication (step S1504). The Web server 40 performs processings required when an HTTP request is determined as a legal request, including the creation of a response in accordance with the HTTP request and the like (step S1505). The response transmission section 134 transmits the response created by the Web server 40 to the client device 10 (step S1506).

Conversely, if it is determined by the determination section 34 that the HTTP request is not to be transmitted to the Web server 40, i.e., if it is estimated that the HTTP request is an illegal request or the estimation value DI of the HTTP request is not lower than the threshold value (“No” at step S1503), the transmitter 35 rejects the transmission of the HTTP request to the Web server 40 (step S1507). The respective sections of the request filter 131 perform processings required when an HTTP request is determined as an illegal request, including the abandonment of the illegal request, the storage of information on the illegal request in a storage medium, the notification of information on the illegal request to an external device and the like (step S1508).

The pseudo-response creation section 132 creates a pseudo-response corresponding to the pattern of the HTTP request which is determined as an illegal access and is not transmitted to the Web server 40 based on the pseudo-response DB 133 and on the predetermined creation rule 132a (step S1509). Specifically, the pseudo-response creation section 133 creates a pseudo-response using the pseudo-password file stored in the pseudo-response DB 133, a pseudo-response using the pseudo-login banner stored in the pseudo-response DB 133, or the like. Thereafter, the response transmission section 134 transmits the pseudo-response created by the pseudo-response creation section 132 to the client device 10 (step S1510).

Through a series of the above-mentioned processings, the pseudo-response indicating that the illegal access is successful or successfully proceeding is transmitted to the client device 10 which has transmitted the HTTP request corresponding to the illegal access pattern to the Web server 40.

As explained above, according to the eighth embodiment, the pseudo-response DB 133 which stores the pseudo-response indicating that the illegal access to the Web server 40 is successful or successfully proceeding to correspond to the illegal access pattern is introduced. It is, therefore, possible to transmit the pseudo-response indicating that the illegal access is successful or successfully proceeding to the client device 10 which has tried to illegally access the Web server 40. As a result, it is possible to play for time without letting the cracker notice the failure of the illegal access, to prevent another new illegal access and to analyze the cracking trick of the cracker. Therefore, it is possible to further ensure protecting the Web server 40 from the illegal access by each client device 10.

In the eighth embodiment, the instance of executing the pattern-based filtering processing to the HTTP request transmitted from the client device 10 has been explained. However, this invention is not limited to this instance but is also applicable to the instance of executing the predetermination processing explained in the third embodiment, the statistic-based filtering processing explained in the fourth embodiment, or the response filtering processing explained in the sixth embodiment as well as the pattern-based filtering processing.

That is, if the pattern-based filtering processing is executed together with the response filtering processing explained in the sixth embodiment, for example, a pseudo-response indicating that an illegal access is successful or successfully proceeding (e.g., pseudo-directory information) is stored in the pseudo-response DB 133 while making the pseudo-response correspond to the illegal response pattern.

If the pattern-based filtering processing is executed together with the statistic-based filtering processing explained in the fourth embodiment, it is effective not to create a pseudo-response for the HTTP response which is abandoned by the statistic-based filtering processing for the following reason. If such a pseudo-response corresponding to the HTTP response intended at server down is created, the burden of the pseudo-response creation processing rather increases.

A ninth embodiment of this invention will be explained below. In the eighth embodiment, the instance of creating the pseudo-response while referring to the pseudo-response DE 133 which stores the pseudo-response corresponding to the pattern of the illegal access to the Web server 40 has been explained. However, this invention is not limited to this instance and is also applicable to an instance of creating a pseudo-response by a pseudo-Web server which receives an HTTP request that is determined as an illegal access and is not transmitted to the Web server 40 and which functions as the decoy of the Web server 40.

That is, there is an illegal access to the Web server 40 which cannot be recognized as a pattern. For the illegal access, a pseudo-response cannot be created while referring to the pseudo-response DB 133 as explained in the eighth embodiment. As a result, it is impossible to play for time without letting the cracker notice the failure of the illegal access, to prevent another new illegal access and to analyze the cracking trick of the cracker.

The ninth embodiment is therefore configured to introduce not the pseudo-response DB 133 but a pseudo-Web server which receives an HTTP request that is determined as an illegal access and is not transmitted to the Web server 40, and which creates a pseudo-response indicating that the illegal access is successful or successfully proceeding, and thereby to make it possible to transmit a pseudo-response even to the illegal access which cannot be recognized as a pattern. The configuration of a server device in a server-client system in the ninth embodiment and filtering processing procedures in the ninth embodiment will be explained.

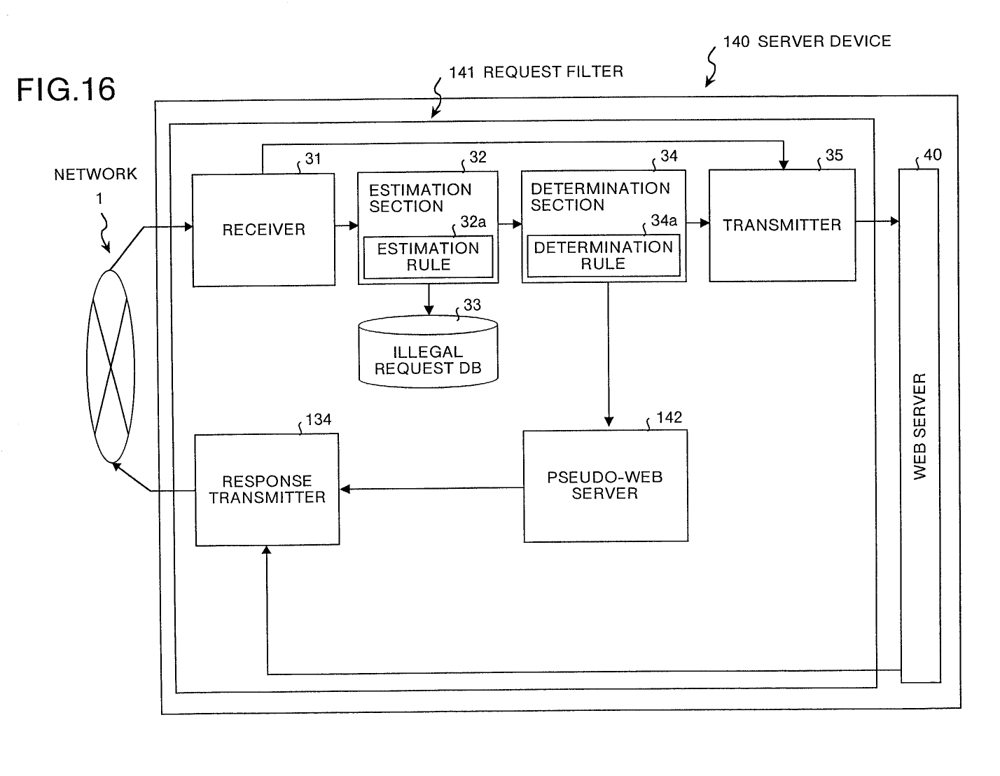

FIG. 16 is a block diagram which shows the configuration of the server-client system in the ninth embodiment. In FIG. 16, sections having the same functions as those shown in FIG. 14 are denoted by the same reference symbols and will not be explained in detail, and a pseudo-Web server 142 which is the characteristic part of the ninth embodiment will be explained herein.

The pseudo-Web server 142 of a request filter 141 in a server device 140 is a processing section which receives an HTTP request that is determined as an illegal access and is not transmitted to a Web server 40, which creates a pseudo-response indicating that the illegal access is successful or successfully proceeding, and which functions as the decoy of the Web server 40. Specifically, as in the instance of the Web server 40, the pseudo-Web server 142 provides a service such as the transmission of various information described in a markup language such as the HTML (HyperText Markup Language) in accordance with the HTTP request, to each client device 10. The pseudo-Web server 40 owns pseudo-data to provide a pseudo-service or create a pseudo-response so as to function as the decoy of the Web server 40.

The pseudo-Web server 142 performs the following processings. For example, the pseudo-Web server 142 receives an illegal HTTP request which requests a password file on the Web server 40 and creates a pseudo-password file, receives an illegal HTTP request to execute an arbitrary system command on the Web server 40 by a request including a command character string and executes the system command, or receives an illegal HTTP request which requests a file that does not exist on the Web server 40 to thereby stop the function of the Web server 40.

That is, the pseudo-Web server 142 receives an illegal HTTP request and executes a processing in accordance with the illegal HTTP request. Since the pseudo-Web server 142 owns the pseudo-data as the decoy of the Web server 40, a response from the pseudo-Web server 142 is the same as a response from the Web server 40 which receives the illegal HTTP request but is a pseudo response.

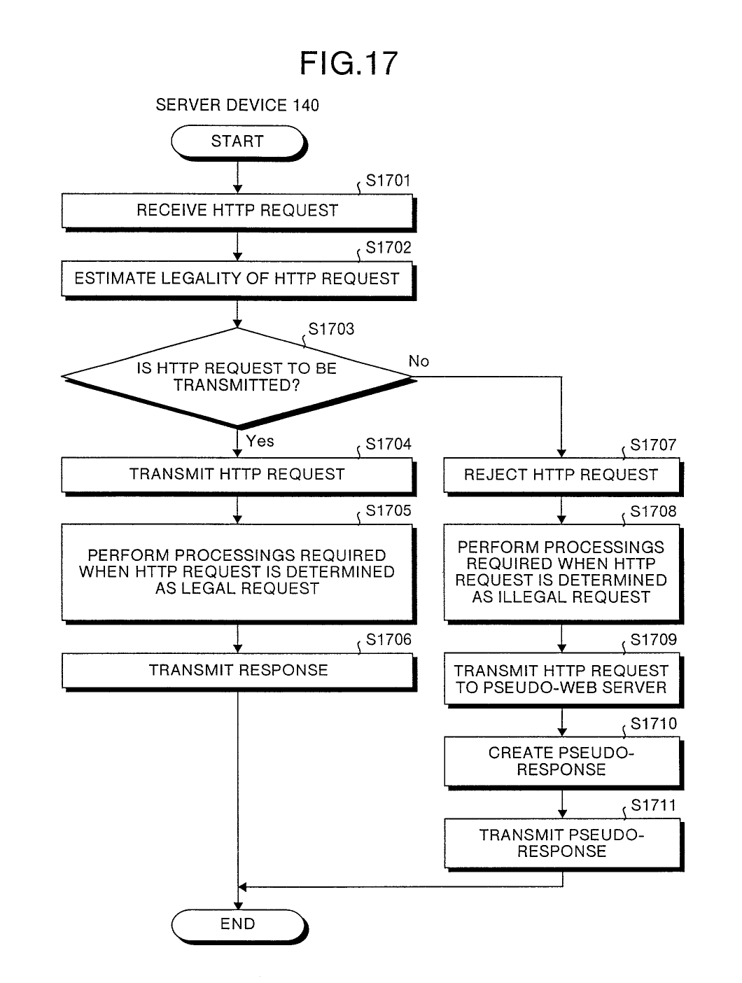

The filtering processing procedures in the ninth embodiment will be explained below. FIG. 17 is a flow chart which explains the filtering processing procedures in the ninth embodiment. As shown in this figure, the request filter 141 in the server device 140 receives an HTTP request from each client device 10 before the Web server 40 receives (step S1701) and executes the same processing as the filtering processing (steps S1501 to S1508 shown in FIG. 15) in the eighth embodiment (steps S1701 to S1708).

As shown in the step S1708, the respective sections of the request filter 141 perform processings required when an HTTP request is determined as an illegal request, including the abandonment of the illegal request, the storage of information on the illegal request in a storage medium, the notification of the information on the illegal request to an external device, and the like (step S1708). The transmitter 35 transmits the HTTP request which is determined as the illegal access and is not transmitted to the Web server 40, to the pseudo-Web server 142 (step S1709).

The pseudo-Web server 142, as the decoy of the Web server 40, creates a pseudo-response indicating that the illegal access is successful or successfully proceeding (step S1710). Specifically, the pseudo-Web server 142 receives the HTTP request which requests a password file on the Web server 40 and creates a pseudo-password file, or receives the HTTP request intended to execute an arbitrary system command on the Web server 40 by the request including a command character string and executes the system command. The response transmission section 134 transmits the pseudo-response created by the pseudo-Web server 142 to the client device 10 (step S1711).

Through a series of the above-mentioned processings, the pseudo-response indicating that the illegal access is successful or successfully proceeding is transmitted to the client device 10 that has transmitted the HTTP request, which cannot be recognized as an illegal access pattern, to the Web server 40.

As explained above, according to the ninth embodiment, the pseudo-Web server 142 as the decoy of the Web server 40 is introduced. Specifically, this pseudo-Web server 142 receives the HTTP request that is determined as an illegal access and is not transmitted to the Web serve r40, and creates the pseudo-response indicating that the illegal access is successful or successfully proceeding. It is, therefore, possible to transmit the pseudo-response even to the illegal access which cannot be recognized as a pattern. Differently from the decoy system explained in the eighth embodiment, in particular, it is not necessary that the pseudo-Web server 142 is operated while pretending to be the mirror server or test server of the Web server 40 which is to be protected from the illegal access. It is, therefore, considered that the pseudo-Web server 142 is effective in that the pseudo-Web server 142 can substantially become the decoy of the Web server 40.

In the ninth embodiment, the instance of executing the pattern-based filtering processing to the HTTP request transmitted from each client device 10 has been explained. However, this invention is not limited to this instance but is also applicable to the instance of executing the predetermination processing explained in the third embodiment, the statistic-based filtering processing explained in the fourth embodiment, or the response filtering processing explained in the sixth embodiment together with the pattern-based filtering processing.

A tenth embodiment of this invention will be explained below. In the eighth and ninth embodiments, the instance of creating the pseudo-response corresponding to the illegal HTTP request which is not transmitted to the Web server 40 and the instance of receiving the illegal HTTP request and creating the pseudo-response so as to function as the decoy of the Web server 40 have been explained, respectively. However, this invention is not limited to these instances but is also applicable to an instance of executing the processings executed by both the eighth and the ninth embodiments.

That is, in the ninth embodiment, all the illegal HTTP requests which are not transmitted to the Web server 40 are transmitted to the pseudo-Web server 142 and the pseudo-Web server 142 creates pseudo-responses corresponding to these illegal HTTP requests. If even an illegal HTTP request which can be recognized as an illegal access pattern is transmitted to the pseudo-Web server 142, excessive burden is imposed on the pseudo-Web server 142.

In the tenth embodiment, therefore, a pseudo-response is created for an illegal HTTP request which can be recognized as an illegal access pattern while referring to an illegal response DB 133. On the other hand, a pseudo-response is created for an illegal HTTP request which cannot be recognized as an illegal access pattern by the pseudo-Web server 142. By doing so, the pseudo-response can be created efficiently and promptly. The configuration of a server device in a server-client system in the tenth embodiment and filtering processing procedures in the tenth embodiment will be explained.

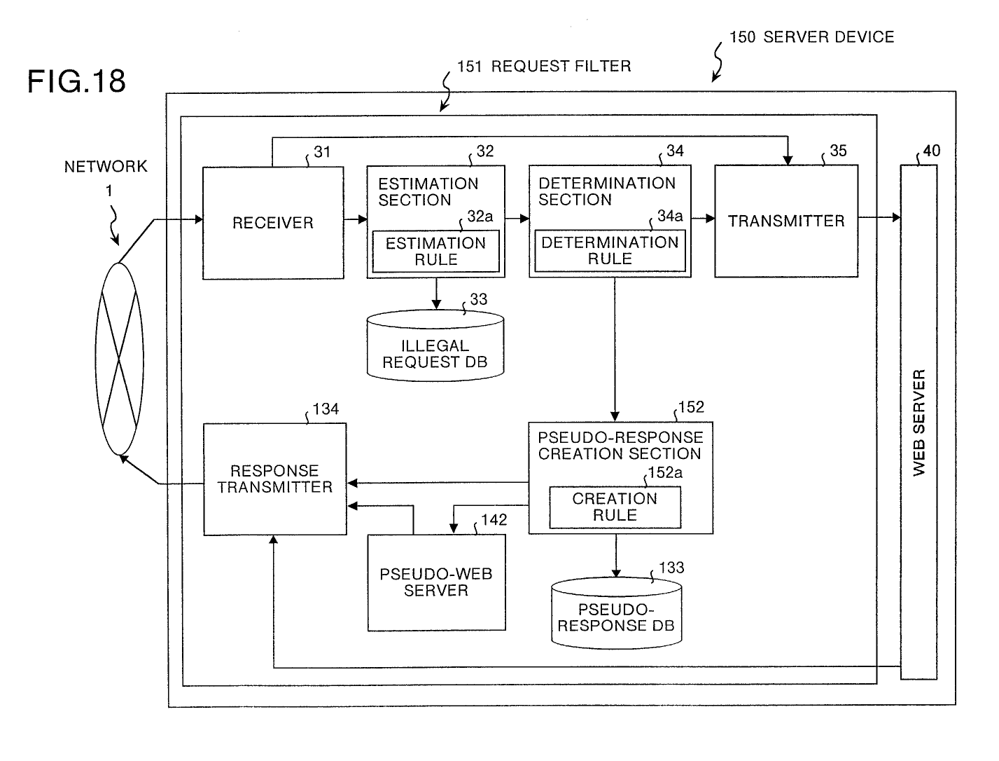

FIG. 18 is a block diagram which shows the configuration of the server-client system in the tenth embodiment. In this figure, sections having the same functions as those show in FIG. 14 or 16 are denoted by the same reference symbols and will not be explained in detail, and a pseudo-response creation section 152 which is the characteristic part of the tenth embodiment will be explained.

The pseudo-response creation section 152 of a request filter 151 in a server device 150 is a processing section which creates a pseudo-response corresponding to an HTTP request pattern, that is determined as an illegal access and is not transmitted to the Web server 40 based on a pseudo-response DB 133 and a predetermined creation rule 152a, and which transmits an HTTP request for which a pseudo-response cannot be created to the pseudo-Web server 142.

Specifically, the pseudo-response creation section 152 receives an HTTP request which is determined as an illegal access and is not transmitted to the Web server 40 from the transmitter 35, and determines whether the pattern of this HTTP request corresponds to any one of illegal request patterns stored in the pseudo-response DB 133. If the HTTP request corresponds to any one of the illegal request patterns, the pseudo-response creation section 152 creates a pseudo-response based on the pseudo-response DB 133 as in the instance of the eighth embodiment. On the other hand, if the HTTP request does not correspond to any one of the illegal request patterns, the pseudo-response creation section 152 transmits the HTTP request to the pseudo-Web server 142 to allow the pseudo-Web server 142, as the decoy of the Web server 40, to create a pseudo-response as in the instance of the ninth embodiment.

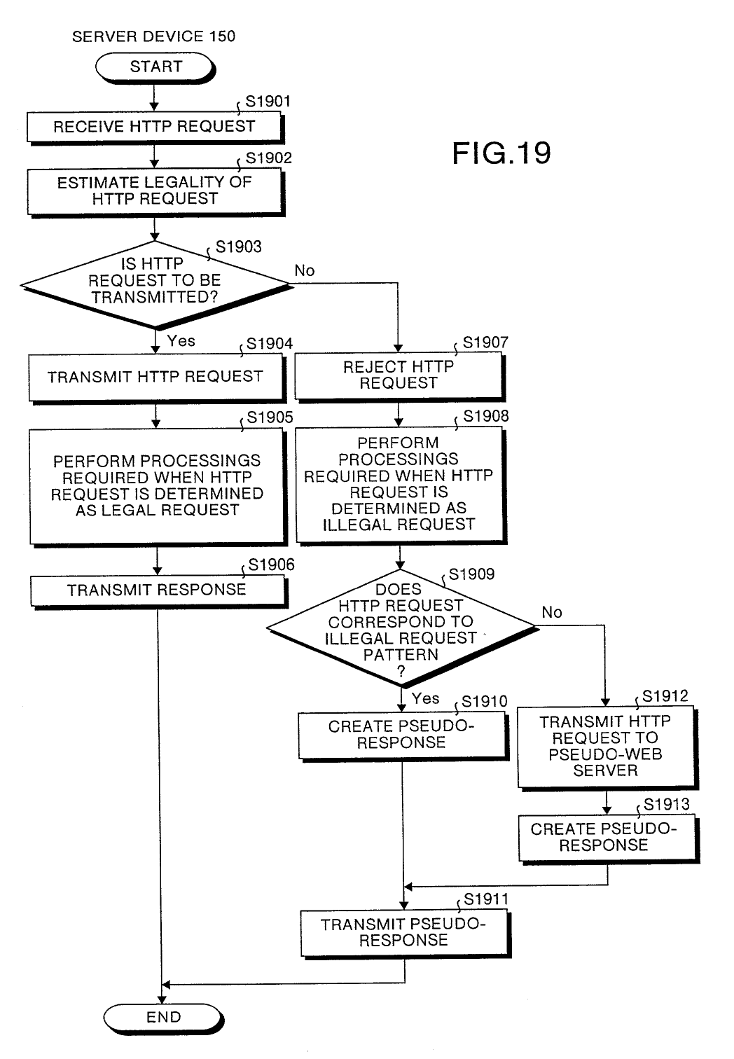

The filtering processing procedures in the tenth embodiment will be explained below. FIG. 19 is a flow chart which explains the filtering processing procedures in the tenth embodiment. As shown in this figure, the request filter 151 in the server device 150 receives an HTTP request from each client device 10 before the Web server 40 receives (step S1901) and executes the same processing as the filtering processing (steps S1501 to S1508 shown in FIG. 15) in the eighth embodiment (steps S1901 to S1908).

As shown in the step S1908, the respective sections of the request filter 151 perform processings required when an HTTP request is determined as an illegal request, including the abandonment of the illegal request, the storage of information on the illegal request in a storage medium, the notification of the information on the illegal request to an external device, and the like (step S1908). The pseudo-response creation section 152 determines whether the pattern of the HTTP request thus abandoned corresponds to the illegal request pattern stored in the pseudo-response DB 133 (step S1909).

If determining that the abandoned HTTP request corresponds to the illegal request pattern (“Yes” at step S1909), the pseudo-response creation section 152 creates a pseudo-response corresponding to the pattern of the HTTP request which is determined as an illegal access and is not transmitted to the Web server 40 based on the pseudo-response DB 133 and on the predetermined creation rule 152a (step S1910). The response transmission section 134 transmits the pseudo-response created by the pseudo-response creation section 152 to the client device 10 (step S1911).

Conversely, if determining that the abandoned HTTP request does not correspond to the illegal request pattern (“No” at step S1909), the pseudo-response creation section 152 transmits the HTTP request which does not correspond to the pattern, to the pseudo-Web server 142 (step S1912). The pseudo-Web server 142, as the decoy of the Web server 40, creates a pseudo-response indicating that the illegal access is successful or successfully proceeding (step S1913) The response transmission section 134 transmits the pseudo-response created by the pseudo-Web server 142 to the client device 10 (step S1911).

Through a series of the above-mentioned processings, the pseudo-response is created by the pseudo-response creation section 152 for the illegal HTTP request which can be recognized as an illegal access pattern while the illegal response DB 133 is referred to. The pseudo-response is created by the pseudo-Web server 142 for the illegal HTTP request which cannot be recognized as an illegal access pattern.

As explained above, according to the tenth embodiment, the pseudo-response is created by the pseudo-response creation section 152 for the illegal HTTP request which can be recognized as an illegal access pattern while the illegal response DB 133 is referred to. The pseudo-response is created by the pseudo-Web server 142 for the illegal HTTP request which cannot be recognized as an illegal access pattern. It is, therefore, possible to create the pseudo-response efficiently and promptly without imposing excessive burden on the pseudo-Web server 142.

In the tenth embodiment as in the instance of the preceding embodiments, the instance of executing the pattern-based filtering processing to the HTTP request transmitted from each client device 10 has been explained. However, this invention is not limited to this instance but is also applicable to the instance of executing the predetermination processing explained in the third embodiment, the statistic-based filtering processing explained in the fourth embodiment, or the response filtering processing explained in the sixth embodiment together with the pattern-based filtering processing as in the instance of the eighth and ninth embodiments.

Other embodiments of this invention will be explained below. While the embodiments of this invention have been explained so far, this invention may be carried out by various embodiments other than those embodiments explained above within the scope of the technical concept of the claims which follow.

In the fourth to tenth embodiments, for example, the instance of filtering the HTTP request from each client device 10 has been explained. However, this invention is not limited to this instance but is also applicable to an instance of filtering any types of information, such as an FTP (File Transfer Protocol), a telnet or a console, input from each client device 10 into the Web server 40.

In addition, in the fourth to tenth embodiments, the instance of providing the request filter, which serves as a filtering apparatus, in the server device has been explained. However, this invention is not limited to this instance but is also applicable to any types of system configurations in which the request filter is interposed between the client devices and the Web server such as, a configuration in which a request filter is provided on each client device side or a plurality of Web server are protected by one request filter, or the like.

The filtering method explained in the fourth to tenth embodiments can be realized by allowing a computer, such as a personal computer or a workstation, to execute a program prepared in advance. This program can be distributed through the network such as the Internet. Alternatively, this program can be executed by recording the program in a computer readable recording medium such as a hard disk, a flexible disk (FD), a CD-ROM, an MO or a DVD, and allowing a computer to read the program from the recording medium.

As explained so far, according to one aspect of this invention, the legality of each of the access requests is estimated based on the illegal access patterns stored in the illegal pattern database which stores patterns of illegal accesses to the server and on the predetermined estimation rule, and it is determined whether each of the access requests is to be transmitted to the server based on this estimation result and on the predetermined determination rule. It is, therefore, possible to determine whether the access request is an illegal access based on not transmitting end information on the access request but the concrete request content of the access request. It is thereby possible to transmit only the legal access request to the server and to protect the server even from the illegal accesses from the clients who are not recognized as illegal clients.

Further, it is estimated that each of the access requests is an illegal access if the access request corresponds to any one of the illegal access patterns stored in the illegal pattern database, and estimated that the access request is a legal access if the access request does not correspond to any one of the illegal access patterns stored in the illegal pattern database. In addition, it is determined that the access request estimated as the illegal access is not to be transmitted to the server, and determined that the access request estimated as the legal access is to be transmitted to the server. It is, therefore, possible to promptly, surely determine whether the access request is an illegal access according to whether the access request corresponds to any one of the illegal request patterns. It is thereby possible to promptly, surely protect the server even from the illegal accesses from the clients who are not recognized as illegal clients.

Further, a predetermined estimation value is calculated according to a degree to which each of the access requests corresponds to the illegal access patterns stored in the illegal pattern database. In addition, the calculated estimation value is compared with the predetermined threshold value, and it is determined whether the access request is to be transmitted to the server. It is, therefore, possible to determine whether the access request is an illegal access by the comparison of the estimation value with the threshold value while allowing a certain degree of margin. It is there by possible to protect the server even from the illegal accesses from the clients who are not recognized as illegal clients while allowing a certain degree of margin.

Further, it is determined whether each of the access requests corresponds to any one of the legal access patterns stored in the legal pattern database while referring to the legal pattern database which stores patterns of legal accesses to the server before the legality of the access request is estimated. In addition, the legality of only the access request determined not to correspond to any one of the legal access patterns is estimated. It is, therefore, possible to transmit the access request, which corresponds to anyone of the legal access patterns, to the server without estimating the legality thereof and to estimate the legality of only the access request which does not correspond to the legal access pattern. It is thereby possible to determine whether the access request is an illegal access more promptly as a whole.

Further, each of the access request determined not to be transmitted to the server is transmitted to a predetermined external device based on the predetermined external transmission rule. It is, therefore, possible to promptly transmit information on the illegal access to the manager of the server, the manager of the filtering apparatus, the manager of a public institution which monitors the overall network, or the like. It is thereby possible to promptly urge such a manger to take measures for the maintenance of the server.

Further, each of the access requests determined not to be transmitted to the server is stored in a predetermined storage medium based on the predetermined storage rule. It is, therefore, possible to analyze the information on the illegal access stored in the storage medium and to thereby take further measures for the maintenance of the server.

Further, the illegal pattern database, the legal pattern database, the estimation rule, the determination rule, the external transmission rule, the storage rule, or a predetermined update rule is updated based on the predetermined update rule. It is, therefore, possible to register the pattern of a newly discovered illegal access in the illegal pattern database and to thereby readily deal with always developing illegal accesses.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A filtering apparatus which is interposed between a client and a server providing a service in accordance with each of access requests from the client, and which transmits only a legal access request among the access requests to the server, the filtering apparatus comprising:
an illegal pattern database which stores patterns of illegal accesses to the server;
a pattern estimation unit which estimates legality of each of the access requests based on the illegal access patterns stored in the illegal pattern database and on a predetermined pattern estimation rule; and
a pattern determination unit which determines whether each of the access requests is to be transmitted to the server based on the estimation by the pattern estimation unit and on a predetermined pattern determination rule.

2. The filtering apparatus according to claim 1, wherein
the pattern estimation unit estimates that each of the access requests is an illegal access if the access request corresponds to any one of the illegal access patterns stored in the illegal pattern database, and estimates that the access request is a legal access if the access request does not correspond to any one of the illegal access patterns stored in the illegal pattern database; and
the pattern determination unit determines that the access request estimated as the illegal access by the pattern estimation unit is not to be transmitted to the server, and determines that the access request estimated as the legal access by the pattern estimation unit is to be transmitted to the server.

3. The filtering apparatus according to claim 1, wherein
the pattern estimation unit calculates a predetermined estimation value according to a degree to which each of the access requests corresponds to the illegal access patterns stored in the illegal pattern database; and
the pattern determination unit compares the estimation value calculated by the pattern estimation unit with a predetermined threshold value, and determines whether the access request is to be transmitted to the server.

4. The filtering apparatus according to claim 1, further comprising:
a legal pattern database which stores patterns of legal accesses to the server; and
a predetermination unit which predetermines whether each of the access requests corresponds to any one of the legal access patterns stored in the legal pattern database before the estimation unit estimates the legality of the access request,
wherein the pattern estimation unit estimates the legality of only the access request determined not to correspond to any one of the legal access patterns by the predetermination unit.

5. The filtering apparatus according to claim 1, further comprising a external transmission unit which transmits each of the access requests determined not to be transmitted to the server by the pattern determination unit, to a predetermined external device based on a predetermined external transmission rule.

6. The filtering apparatus according to claim 1, further comprising a storage unit which stores each of the access requests determined not to be transmitted to the server by the pattern determination unit, in a predetermined storage medium based on a predetermined storage rule.

7. The filtering apparatus according to claim 1, further comprising a update unit which updates the illegal pattern database, the legal pattern database, the pattern estimation rule, the pattern determination rule, the extern al transmission rule, the storage rule, or a predetermined update rule, based on the predetermined update rule.

8. The filtering apparatus according to claim 1, further comprising:
a statistically illegal request database which stores information on the access requests considered to be illegal accesses from the statistic of the access requests for the server;
a statistic estimation unit which estimates the legality of each of the access requests based on the information stored in the statistically illegal request database and on a predetermined statistic estimation rule;
a statistic determination unit which determines whether the access request is to be transmitted to the server based on the estimation result of the estimation unit and on a predetermined determination rule; and
an access request transmission unit which transmits, as a legal access request, only the access request determined to be transmitted to the server by the pattern and statistic determination units, to the server.

9. The filtering apparatus according to claim 8, wherein
the statistically illegal request database stores transmitting end information on the clients each of which issues access requests within a predetermined time, the number of the access requests exceeding a predetermined number, among the clients who transmit the access requests to the server;
the statistic estimation unit estimates that each of the access requests is the illegal access if the transmitting end information on the access request corresponds to any one of the transmitting end information stored in the statistically illegal request database, and estimates that the access request is the legal access if the transmitting end information on the access request does not correspond to any one of the transmitting end information stored in the statistically illegal request database; and
the statistic determination unit determines that the access request estimated as the illegal access by the statistic estimation unit is not to be transmitted to the server, and determines that the access request estimated as the legal access by the statistic estimation unit is to be transmitted to the server.

10. The filtering apparatus according to claim 8, wherein
the statistically illegal request database stores request contents of the access requests within a predetermined time, the number of the access requests of each request content exceeding a predetermined number, among request contents of the access requests transmitted to the server;
the statistic estimation unit estimates that the access request of each of the access requests is the illegal access if the request content of the access request corresponds to any one of the request contents stored in the statistically illegal request database, and estimates that the access request is the legal access if the request content of the access request does not correspond to any one of the request contents stored in the statistically illegal request database; and
the statistic determination unit determines that the access request estimated as the illegal access by the statistic estimation unit is not to be transmitted to the server, and determines that the access request estimated as the legal access by the statistic estimation unit is to be transmitted to the server.

11. The filtering apparatus according to claim 8, wherein
the statistically illegal request database stores transmitting end information on the clients each of which issues access requests, the number of which exceeds a predetermined number within a predetermined time, among the clients who transmit the access requests to the server, and stores request contents of the access requests, the number of which exceeds a predetermined number within a predetermined time, among the request contents of the access requests transmitted to the server;
the statistic estimation unit estimates that each of the access requests is the illegal access if the transmitting end information on the access request corresponds to any one of the transmitting end information stored in the statistically illegal request database or the request content of the access request corresponds to any one of the request contents stored in the statistically illegal request database, and estimates that the access request is the legal access if the transmitting end information on the access request does not correspond to any one of the transmitting end information stored in the statistically illegal request database and the request content of the access requests does not correspond to any one of the request contents stored in the statistically illegal request database; and
the statistic determination unit determines that the access request estimated as the illegal access by the statistic estimation unit is not to be transmitted to the server, and determines that the access request estimated as the legal access by the statistic estimation unit is to be transmitted to the server.

12. The filtering apparatus according to claim 8, wherein
the statistically illegal request database stores transmitting end information on the clients each of which issues access requests, the number of which exceeds a predetermined number within a predetermined time, among the clients who transmit the access requests to the server, and stores request contents of the access requests, the number of which a predetermined number within a predetermined time, among the request contents of the access requests transmitted to the server;
the statistic estimation unit calculates a predetermined estimation value according to a degree to which the transmitting end information on each of the access requests and the request content of the access request correspond to the transmitting end information and the request contents stored in the statistically illegal request database, respectively; and
the statistic determination unit compares the estimation value calculated by the statistic estimation unit with a predetermined threshold value, and determines whether the access request is to be transmitted to the server.

13. The filtering apparatus according to claim 8, wherein the statistic estimation unit estimates the legality of only the access request determined to be transmitted to the server by the pattern determination unit.

14. The filtering apparatus according to claim 8, wherein the pattern estimation unit estimates the legality of only the access request determined to be transmitted to the server by the statistic determination unit.

15. The filtering apparatus according to claim 8, wherein the predetermination unit predetermines whether only the access request determined to be transmitted to the server by the statistic determination unit corresponds to any one of the legal access patterns stored in the legal pattern database.

16. The filtering apparatus according to claims 8, further comprising a external transmission unit which transmits the access requests which are not transmitted to the server by the access request transmission unit, to the predetermined external device based on a predetermined external transmission rule.

17. The filtering apparatus according to claim 8, further comprising a storage unit which stores the access requests which are not transmitted to the server by the access request transmission unit, to the predetermined storage medium based on a predetermined storage rule.

18. The filtering apparatus according to claim 8, further comprising a update unit which updates the statistically illegal request database, the statistic estimation rule, the statistic determination rule, the external transmission rule, and at least one of the storage rule and a predetermined update rule, based on at least one of the predetermined update rule and the statistic of the access requests to the server.

19. The filtering apparatus according to claim 18, wherein the update unit performs any one or both of addition and deletion of at least one of the transmitting end information and the request contents stored in the statistically illegal request database, according to any one or both of the number of access requests for each client who transmits the access requests to the server within the predetermined time and the number of access requests for each request content of the access requests transmitted to the server within the predetermined time.

20. The filtering apparatus according to claim 1, further comprising:
an illegal response database which stores patterns of illegal responses which should not be transmitted to each of the clients among the responses transmitted from the server to each of the clients as the service in accordance with the respective access requests;
a response estimation unit which estimates the legality of each of the responses based on the illegal response patterns stored in the illegal response database and a predetermined response estimation rule;
a response determination unit which determines whether the response is to be transmitted to the client based on an estimation result of the response estimation unit and on a predetermined response determination rule; and
a response transmission unit which transmits, as a legal response, only the response determined to be transmitted to the client by the response determination unit, to the client.

21. The filtering apparatus according to claim 20, wherein
the response estimation unit estimates that the response is an illegal response if the response corresponds to any one of the illegal response patterns stored in the illegal response database, and estimates that the response is a legal response if the response does not correspond to any one of the illegal response patterns stored in the illegal response database; and
the response determination unit determines that the response estimated as the illegal response by the response estimation unit, is not to be transmitted to the client, and determines that the response estimated as the legal response by the response estimation unit, is to be transmitted to the client.

22. The filtering apparatus according to claim 20, wherein
the response estimation unit calculates a predetermined estimation value according to a degree to which the response corresponds to the illegal response patterns stored in the illegal response database; and
the response determination unit compares the estimation value calculated by the response estimation unit with a predetermined threshold value, and determines whether the response is to be transmitted to the client.

23. The filtering apparatus according to claim 20, further comprising an external transmission unit which transmits at least one of the response that is not transmitted to the client by the response transmission unit and the access request causing the response, to a predetermined external device based on a predetermined external transmission rule.

24. The filtering apparatus according to claim 20, further comprising an storage unit which stores at least one of the response that is not transmitted to the client by the response transmission unit and the access request causing the response, in the predetermined storage medium based on a predetermined storage rule.

25. The filtering apparatus according to claim 20, further comprising an update unit which updates the illegal response database, the response estimation rule, the response determination rule, the external transmission rule, and at least one of the storage rule and a predetermined update rule, based on a predetermined update rule.

26. The filtering apparatus according to claim 1, further comprising an access request decryption unit which decrypts an access request which has been subjected to a predetermined encryption processing,
wherein the pattern estimation unit, the predetermination unit or the statistic estimation unit estimates or determines the access request decrypted by the access request decryption unit.

27. The filtering apparatus according to claim 26, wherein if only the legal access request among the access requests is to be transmitted to the server, not the access request decrypted by the access request decryption unit but the access request which has been subjected to the predetermined encryption processing is transmitted to the server.

28. The filtering apparatus according to claim 26, further comprising a response decryption unit which decrypts a response which has been subjected to a predetermined encryption processing, wherein the response estimation unit estimates the response decrypted by the response decryption unit.

29. The filtering apparatus according to claim 28, wherein if only the legal response among the responses is to be transmitted to the client, not the response decrypted by the response decryption unit but the response which has been subjected to the predetermined encryption processing is transmitted to the client.

30. The filtering apparatus according to claim 1, further comprising:
a pseudo-response database which stores pseudo-responses corresponding to the patterns of the illegal accesses to the server, respectively, and each indicating that the corresponding illegal access is successful or successfully proceeding;
a pseudo-response creation unit which creates pseudo-responses corresponding to the patterns of the access requests, each of which is determined as the illegal access and is not transmitted to the server, respectively while referring to the pseudo-response database; and
a pseudo-response transmission unit which transmits the pseudo-responses created by the pseudo-response creation unit to the clients, respectively.

31. The filtering apparatus according to claim 1, further comprising:
a decoy unit which receives the access requests each of which is determined as the illegal access and is not transmitted to the server, and creates, as a decoy of the sever, pseudo-responses each indicating that the corresponding illegal access is successful or successfully proceeding; and
a pseudo-response transmission unit which transmits the pseudo-responses created by the decoy unit to the clients, respectively.

32. The filtering apparatus according to claim 1, further comprising:
a pseudo-response database which stores pseudo-responses corresponding to the patterns of the illegal accesses to the server, respectively, and each indicating that the corresponding illegal access is successful or successfully proceeding;
a pseudo-response creation unit which creates pseudo-responses corresponding to the illegal access patterns stored in the pseudo-response database among the access requests each of which is determined as the illegal access and is not transmitted to the server;
a decoy unit which receives the access requests which do not correspond to the illegal access patterns stored in the pseudo-response database among the access requests each of which is determined as the illegal access and is not transmitted to the server, and creates, as a decoy of the sever, pseudo-responses each indicating that the corresponding illegal access is successful or successfully proceeding; and
a pseudo-response transmission unit which transmits the pseudo-responses created by the pseudo-response creation unit or the decoy unit to the clients, respectively.

33. A filtering method used on a client and a server providing a service in accordance with each of access requests from the client, and which transmits only a legal access request among the access requests to the server, the method comprising:
a pattern estimation step of referring to an illegal pattern database which stores patterns of illegal accesses to the server, and estimating legality of each of the access requests based on the illegal access patterns referred to and on a predetermined pattern estimation rule; and
a pattern determination step of determining whether each of the access requests is to be transmitted to the server based on an estimation result at the pattern estimation step and on a predetermined pattern determination rule.

34. The filtering method according to claim 33, wherein
the pattern estimation step includes estimating that each of the access requests is an illegal access if the access request corresponds to anyone of the illegal access patterns stored in the illegal pattern database, and estimating that the access request is a legal access if the access request does not correspond to any one of the illegal access patterns stored in the illegal pattern database; and
the pattern determination step includes determining that the access request estimated as the illegal access in the pattern estimation step is not to be transmitted to the server, and determining that the access request estimated as the legal access in the pattern estimation step is to be transmitted to the server.

35. The filtering method according to claim 33, wherein
the pattern estimation step includes calculating a predetermined estimation value according to a degree to which each of the access requests corresponds to the illegal access patterns stored in the illegal pattern database; and
the pattern determination step includes comparing the estimation value calculated in the pattern estimation step with a predetermined threshold value, and determining whether the access request is to be transmitted to the server.

36. The filtering method according to claim 33, further comprising a predetermination step of referring to a legal pattern database which stores patterns of legal accesses to the server, and determining whether each of the access requests corresponds to any one of the legal access patterns stored in the legal pattern database before the legality of the access request is estimated in the estimation step,
wherein the pattern estimation step includes estimating the legality of only the access request determined not to correspond to any one of the legal access patterns in the predetermination step.

37. The filtering method according to claim 33, further comprising an external transmission step of transmitting each of the access requests determined not to be transmitted to the server in the pattern determination step, to a predetermined external device based on a predetermined external transmission rule.

38. The filtering method according to claim 33, further comprising a storage step of storing each of the access requests determined not to be transmitted to the server in the pattern determination step, in a predetermined storage medium based on a predetermined storage rule.

39. The filtering method according to claim 33, further comprising an update step of updating the illegal pattern database, the legal pattern database, the pattern estimation rule, the pattern determination rule, the external transmission rule, the storage rule, or a predetermined update rule, based on the predetermined update rule.

40. The filtering method according to claim 33, further comprising:
a statistic estimation step of referring to a statistically illegal request database which stores information on the access requests considered to be illegal accesses from the statistic of the access requests for the server, and estimating the legality of each of the access requests based on a predetermined statistic estimation rule;
a statistic determination step of determining whether the access request is to be transmitted to the server based on the estimation in the estimation step and on a predetermined determination rule; and
an access request transmission step of transmitting, as a legal access request, only the access request determined to be transmitted to the server in the pattern and statistic determination steps, to the server.

41. The filtering method according to claim 40, wherein
the statistically illegal request database stores transmitting end information on the clients each of which issues access requests, the number of which exceeds a predetermined number within a predetermined time, among the clients who transmit the access requests to the server;
the statistic estimation step includes estimating that each of the access requests is the illegal access if the transmitting end information on the access request corresponds to any one of the transmitting end information stored in the statistically illegal request database, and estimating that the access request is the legal access if the transmitting end information on the access request does not correspond to any one of the transmitting end information stored in the statistically illegal request database; and
the statistic determination step includes determining that the access request estimated as the illegal access in the statistic estimation step is not to be transmitted to the server, and determining that the access request estimated as the legal access in the statistic estimation step is to be transmitted to the server.

42. The filtering method according to claim 40, wherein
the statistically illegal request database stores request contents of the access requests, the number of which exceeds a predetermined number within a predetermined time, among the request contents of the access requests transmitted to the server;
the statistic estimation step includes estimating that each of the access requests is the illegal access if the request content of the access request corresponds to any one of the request contents stored in the statistically illegal request database, and estimating that the access request is the legal access if the request content of the access request does not correspond to any one of the request contents stored in the statistically illegal request database; and
the statistic determination step includes determining that the access request estimated as the illegal access in the statistic estimation step is not to be transmitted to the server, and determining that the access request estimated as the legal access in the statistic estimation step is to be transmitted to the server.

43. The filtering method according to claim 40, wherein
the statistically illegal request database stores transmitting end information on the clients each of which issues access requests, the number of which exceeds a predetermined number within a predetermined time, among the clients who transmit the access requests to the server, and stores request contents of the access requests, the number of which exceeds a predetermined number within a predetermined time, among the request contents of the access requests transmitted to the server;
the statistic estimation step includes estimating that each of the access requests is the illegal access if the transmitting end information on the access request corresponds to any one of the transmitting end information stored in the statistically illegal request database, or if the request content of the access request corresponds to any one of the request contents stored in the statistically illegal request database, and estimating that the access request is the legal access if the transmitting end information on the access request does not correspond to any one of the transmitting end information stored in the statistically illegal request database, and if the request content of the access requests does not correspond to any one of the request contents stored in the statistically illegal request database; and
the statistic determination step includes determining that the access request estimated as the illegal access in the statistic estimation step is not to be transmitted to the server, and determining that the access request estimated as the legal access in the statistic estimation step is to be transmitted to the server.

44. The filtering method according to claim 40, wherein
the statistically illegal request database stores transmitting end information on the clients each of which issues access requests, the number of which exceeds a predetermined number within a predetermined time, among the clients who transmit the access requests to the server, and stores request contents of the access requests, the number of which exceeds a predetermined number within a predetermined time, among the request contents of the access requests transmitted to the server;
the statistic estimation step includes calculating a predetermined estimation value according to a degree to which the transmitting end information on each of the access requests and the request content of the access request correspond to the transmitting end information and request contents stored in the statistically illegal request database, respectively; and
the statistic determination step includes comparing the estimation value calculated in the statistic estimation step with a predetermined threshold value, and determining whether the access request is to be transmitted to the server.

45. The filtering method according to claim 40, wherein the statistic estimation step includes estimating the legality of only the access request determined to be transmitted to the server in the pattern determination step.

46. The filtering method according to claim 40, wherein the pattern estimation step includes estimating the legality of only the access request determined to be transmitted to the server in the statistic determination step.

47. The filtering method according to claim 40, wherein the predetermination step includes predetermining whether only the access request, determined to be transmitted to the server in the statistic determination step, corresponds to any one of the legal access patterns stored in the legal pattern database.

48. The filtering method according to claim 40, further comprising an external transmission step of transmitting the access requests which are not transmitted to the server in the access request transmission step, to the predetermined external device based on a predetermined external transmission rule.

49. The filtering method according to claim 40, further comprising a storage step of storing the access requests which are not transmitted to the server in the access request transmission step, to the predetermined storage medium based on a predetermined storage rule.

50. The filtering method according to claim 40, further comprising an update step of updating the statistically illegal request database, the statistic estimation rule, the statistic determination rule, the external transmission rule, and at least one of the storage rule and a predetermined update rule, based on at least one of the predetermined update rule and the statistic of the access requests to the server.

51. The filtering method according to claim 50, wherein
the update step includes any one or both of addition and deletion of at least one of the transmitting end information and the request contents stored in the statistically illegal request database, according to any one or both of the number of access requests for each client who transmits the access requests to the server within a predetermined time and the number of access requests for each request content of the access requests transmitted to the server within a predetermined time.

52. The filtering method according to claim 33, further comprising:
a response estimation step of referring to an illegal response database which stores patterns of illegal responses that should not be transmitted to each of the clients, among the responses transmitted from the server to each of the clients as the service according to the respective access requests, and estimating the legality of each of the responses based on the predetermined response estimation rule;
a response determination step of determining whether the response is to be transmitted to the client based on an estimation in the response estimation step and on the predetermined response determination rule; and
a response transmission step of transmitting, as a legal response, only the response determined to be transmitted to the client in the response determination step, to the client.

53. The filtering method according to claim 52, wherein
the response estimation step includes estimating that the response is an illegal response if the response corresponds to any one of the illegal response patterns stored in the illegal response database, and estimating that the response is a legal response if the response does not correspond to any one of the illegal response patterns stored in the illegal response database; and
the response determination step includes determining that the response estimated as the illegal response in the response estimation step, is not to be transmitted to the client, and determining that the response estimated as the legal response in the response estimation step, is to be transmitted to the client.

54. The filtering method according to claim 52, wherein
the response estimation step includes calculating a predetermined estimation value according to a degree to which the response corresponds to the illegal response patterns stored in the illegal response database; and
the response determination step includes comparing the estimation value calculated in the response estimation step with a predetermined threshold value, and determining whether the response is to be transmitted to the client.

55. The filtering method according to claim 52, further comprising an external transmission step of transmitting at least one of the response which is not transmitted to the client in the response transmission step and the access request causing the response, to a predetermined external device based on a predetermined external transmission rule.

56. The filtering method according to claim 52, further comprising a storage step of storing at least one of the response which is not transmitted to the client in the response transmission step and the access request causing the response, in the predetermined storage medium based on a predetermined storage rule.

57. The filtering method according to claim 52, further comprising an update step of updating the illegal response database, the response estimation rule, the response determination rule, the external transmission rule, at least one of the storage rule and a predetermined update rule, based on the predetermined update rule.

58. The filtering method according to claim 33, further comprising an access request decryption step of decrypting an access request which has been subjected to a predetermined encryption processing, wherein
the pattern estimation step, the predetermination step, or the statistic estimation step includes estimating or determining the access request decrypted in the access request decryption step.

59. The filtering method according to claim 58, further comprising:
transmitting not the access request decrypted in the access request decryption step but the access request which has been subjected to the predetermined encryption processing, to the server if only the legal access request among the access requests is to be transmitted to the server.

60. The filtering method according to claim 58, further comprising a response decryption step of decrypting a response which has been subjected to a predetermined encryption processing, wherein
the response estimation step includes estimating the response decrypted in the response decryption step.

61. The filtering method according to claim 60, further comprising:
transmitting not the response decrypted in the response decryption step but the response which has been subjected to the predetermined encryption processing, to the client if only the legal response among the responses is to be transmitted to the client.

62. The filtering method according to claim 33, further comprising:
a pseudo-response creation step of referring to a pseudo-response database which stores pseudo-responses corresponding to the patterns of the illegal accesses to the server, respectively, and each indicating that the corresponding illegal access is successful or successfully proceeding, and creating pseudo-responses corresponding to the patterns of the access requests, each of which is determined as the illegal access and is not transmitted to the server, respectively; and
a pseudo-response transmission step of transmitting the pseudo-responses created in the pseudo-response creation step to the clients, respectively.

63. The filtering method according to claim 33, further comprising:
a decoy step of receiving the access requests each of which is determined as the illegal access and is not transmitted to the server, and creating, as a decoy of the sever, pseudo-responses each indicating that the corresponding illegal access is successful or successfully proceeding; and
a pseudo-response transmission step of transmitting the pseudo-responses created in the decoy step to the clients, respectively.

64. The filtering method according to claim 33, further comprising:
a pseudo-response creation step of referring to a pseudo-response database which stores pseudo-responses corresponding to the patterns of the illegal accesses to the server, respectively, and each indicating that the corresponding illegal access is successful or successfully proceeding, and creating pseudo-responses corresponding to the illegal access patterns stored in the pseudo-response database among the access requests each of which is determined as the illegal access and is not transmitted to the server;
a decoy step of receiving the access requests which do not correspond to the illegal access patterns stored in the pseudo-response database among the access requests each of which is determined as the illegal access and is not transmitted to the server, and creating, as a decoy of the sever, pseudo-responses each indicating that the corresponding illegal access is successful or successfully proceeding; and
a pseudo-response transmission step of transmitting the pseudo-responses created in the pseudo-response creation step or the decoy step to the clients, respectively.

65. A computer program containing instructions which when executed on a computer causes the computer to perform a filtering method used on a client and a server providing a service in accordance with each of access requests from the client, and which transmits only a legal access request among the access requests to the server, the filtering method comprising:
a pattern estimation step of referring to an illegal pattern database which stores patterns of illegal accesses to the server, and estimating legality of each of the access requests based on the illegal access patterns referred to and on a predetermined pattern estimation rule; and
a pattern determination step of determining whether each of the access requests is to be transmitted to the server based on an estimation result at the pattern estimation step and on a predetermined pattern determination rule.
